(19) United States
(12) Patent Application Publication
(10) Pub. No.: US 2020/0209596 A1
(43) Pub. Date: Jul. 2, 2020

(54) IMAGING APPARATUS AND ELECTRONIC APPARATUS

(71) Applicant: SONY SEMICONDUCTOR SOLUTIONS CORPORATION, Kanagawa (JP)

(72) Inventor: Katsuji KIMURA, Kanagawa (JP)

(73) Assignee: SONY SEMICONDUCTOR SOLUTIONS CORPORATION, Kanagawa (JP)

(21) Appl. No.: 16/640,925

(22) PCT Filed: Aug. 17, 2018
(86) PCT No.: PCT/JP2018/030494

§ 371 Date: Feb. 21, 2020

(30) Foreign Application Priority Data
Aug. 31, 2017 (JP) 2017-166541

(51) Int. Cl. G02B 13/00; G02B 5/20; H04N 5/225; G02B 27/00

(52) U.S. Cl. CPC G02B 13/0085; G02B 27/0018; H04N 5/2254; G02B 5/20

(57) ABSTRACT

An imaging apparatus includes an imaging structure. The imaging structure includes an imaging element that converts received light into electric charge, a transparent substrate disposed on the imaging element, at least one lens disposed on the transparent substrate, and an air cavity between the transparent substrate and the at least one lens.

### CROSS REFERENCE TO RELATED APPLICATIONS

This application claims the benefit of Japanese Priority Patent Application JP 2017-166541 filed Aug. 31, 2017, the entire contents of which are incorporated herein by reference.

### TECHNICAL FIELD

The present disclosure relates to an imaging apparatus and an electronic apparatus, and more particularly, to an imaging apparatus and an electronic apparatus that are capable of realizing downsizing and reduction in height of the apparatus structure and performing imaging while suppressing occurrence of flare and ghost.

### BACKGROUND ART

In recent years, in a solid-state imaging element used in a camera-equipped mobile terminal apparatus, a digital still camera, and the like, the number of pixels in a camera has been increased and the camera has been downsized and reduced in height.

Along with the increase in number of pixels and the downsizing of the camera, a distance between the lens and the solid-state imaging element in the optical axis is shorter. Thus, it is general to arrange an infrared cut filter in the periphery of the lens.

For example, a technology of forming a lens in a lowermost layer of a lens group including a plurality of lenses on the solid-state imaging element, to thereby downsize the solid-state imaging element has been proposed (see Patent Literature 1).

### CITATION LIST

### Patent Literature

PTL 1: Japanese Patent Application Laid-open No. 2015-061193

### SUMMARY OF INVENTION

### Technical Problem

However, in the case where the lens in the lowermost layer is formed on the solid-state imaging element, it contributes to the downsizing and reduction in height of the apparatus structure, though the distance between the infrared cut filter and the lens is shorter and thus, flare and ghost due to internal diffused reflection of reflection of light occur.

The present disclosure has been made in view of the above circumstances to realize downsizing and reduction in height and suppress occurrence of flare and ghost particularly in a solid-state imaging element.

### Solution to Problem

In accordance with an aspect of the present disclosure, there is provided an imaging apparatus including an imaging structure including an imaging element that converts received light into electric charge; a transparent substrate disposed on the imaging element; at least one lens disposed on the transparent substrate; and an air cavity between the transparent substrate and the at least one lens.

The at least one lens includes a first surface and a second surface opposite to the first surface, and the first surface includes a concave portion.

The second surface includes at least one protrusion fixed to the transparent substrate such that the air cavity is defined between the transparent substrate and the at least one lens.

The at least one protrusion is fixed to the transparent substrate by an adhesive.

The imaging apparatus may further include a circuit substrate including a circuit; a spacer including at least one fixing portion that guides the imaging structure to a desired position on the circuit substrate when the imaging structure is mounted on the circuit substrate; and a light absorbing material disposed on at least one side surface of the imaging structure such that that light absorbing material is between the imaging structure and the at least one fixing portion.

The at least one side surface of the imaging structure includes a side surface of the at least one lens.

The light absorbing material is disposed on the first surface of the at least one lens.

The at least one fixing portion includes four fixing portions that guide the imaging structure to the desired position.

The four fixing portions are defined by a cavity in the spacer and have shapes that guide respective corners of the imaging structure to the desired position, and the at least one side surface of the imaging structure includes side surfaces at locations that correspond to the respective corners.

The light absorbing material is disposed on an entirety of the side surfaces at the locations that correspond to the respective corners.

The imaging structure further comprises an infrared cut filter between the transparent substrate and the at least one lens.

The infrared cut filter is adhered to the second surface of the at least one lens such that the air cavity is between the infrared cut filter and the transparent substrate.

The at least one lens includes a plurality of lenses.

The imaging structure further comprises a lens stack including a plurality of lenses, wherein the lens stack is spaced apart from the at least one lens; and an actuator that supports the lens stack.

The transparent substrate is an infrared cut filter.

The at least one lens includes a first surface and a second surface opposite to the first surface, the first surface includes a concave portion, and the second surface includes at least one protrusion fixed to the infrared cut filter such that the air cavity is defined between the infrared cut filter and the at least one lens. The at least one protrusion is at a peripheral of the at least one lens. The at least one protrusion is fixed to the infrared cut filter at a peripheral of the infrared cut filter.

The displacement between the incident position of the incident light entering the solid-state imaging element and the incident position of the totally-reflected and turned-back component may be substantially constant, the totally-reflected and turned-back component re-entering the solid-state imaging element in such a manner that the incident light is totally reflected on the imaging surface of the solid-state imaging element and the resulting totally-reflected component of the incident light is reflected at the boundary with the cavity layer.

In accordance with an aspect of the present disclosure, there is provided an electronic apparatus including a signal processing unit; and an imaging apparatus. The imaging apparatus includes an imaging structure including an imaging element that converts received light into electric charge; a transparent substrate disposed on the imaging element; at least one lens disposed on the transparent substrate; and an air cavity between the transparent substrate and the at least one lens. The at least one lens includes a first surface and a second surface opposite to the first surface, the first surface includes a concave portion, and the second surface includes at least one protrusion fixed to the transparent substrate such that the air cavity is defined between the transparent substrate and the at least one lens.

In accordance with an aspect of the present disclosure, there is provided a manufacturing method for an imaging apparatus including

a solid-state imaging element configured to photoelectrically convert received light into an electric signal corresponding to an amount of the received light,

a lower layer lens that is a part of a lens group including a plurality of lenses configured to condense the received light, the lower layer lens being placed at a position in front of the solid-state imaging element, the position being closer to the solid-state imaging element than an upper layer lens that is a different part of the lens group, and

a cavity layer including an air layer, the cavity layer being formed between the lower layer lens and the solid-state imaging element, the manufacturing method including:

fixing the solid-state imaging element to a circuit substrate; and

mounting the lower layer lens on the solid-state imaging element such that the cavity layer is formed.

In an aspect of the present disclosure, received light is photoelectrically converted by a solid-state imaging element into an electric signal corresponding to an amount of the received light. A lower layer lens and a cavity layer are formed. The lower layer lens is a part of a lens group including a plurality of lenses configured to condense the received light, the lower layer lens being placed at a position in front of the solid-state imaging element, the position being closer to the solid-state imaging element than an upper layer lens that is a different part of the lens group. The cavity layer includes an air layer, the cavity layer being formed between the lower layer lens and the solid-state imaging element.

### Advantageous Effects of Invention

In accordance with an aspect of the present disclosure, it is possible to realize downsizing and reduction in height of an apparatus structure and suppress occurrence of flare and ghost particularly in a solid-state imaging element.

### BRIEF DESCRIPTION OF DRAWINGS

FIG. 1 is a diagram describing a configuration example of an imaging apparatus according to a first embodiment of the present disclosure.

FIG. 2 is a diagram describing a configuration of a fixing portion provided in a spacer.

FIG. 3 is a diagram describing a principle of suppressing a flare phenomenon.

FIG. 4 is a diagram describing an effect of the present disclosure.

FIG. 5 is a diagram describing an example in which a fixing agent or a mask is formed in an outer peripheral portion of a lens.

FIG. 6 is a diagram describing an example in which the fixing agent is formed around the side surface of a CSP solid-state imaging element and the mask is formed in the outer peripheral portion of the lens.

FIG. 7 is a flowchart describing a manufacturing method for the imaging apparatus illustrated in FIG. 1.

FIG. 8 is a flowchart describing imaging processing for the imaging apparatus illustrated in FIG. 1.

FIG. 9 is a diagram describing a configuration example of an imaging apparatus according to a second embodiment of the present disclosure.

FIG. 10 is a diagram describing a configuration example of an imaging apparatus according to a third embodiment of the present disclosure.

FIG. 11 is a diagram describing a configuration example of an imaging apparatus according to a fourth embodiment of the present disclosure.

FIG. 12 is a diagram describing a configuration example of an imaging apparatus according to a fifth embodiment of the present disclosure.

FIG. 13 is a diagram describing a configuration example of an imaging apparatus according to a sixth embodiment of the present disclosure.

FIG. 14 is a diagram describing an arrangement example of the fixing portion.

FIG. 15 is a diagram describing a configuration example of an imaging apparatus according to a seventh embodiment of the present disclosure.

FIG. 16 is a diagram describing a configuration example of an imaging apparatus according to an eighth embodiment of the present disclosure.

FIG. 17 is a diagram describing a configuration example of a CSP solid-state imaging element according to an embodiment of the present disclosure.

FIG. 18 is a block diagram illustrating a configuration example of an imaging apparatus as an electronic apparatus to which the configuration of the imaging apparatus according to an embodiment of the present disclosure is applied.

FIG. 19 is a diagram describing a usage example of the imaging apparatus to which the technology according to the present disclosure is applied.

FIG. 20 is a block diagram illustrating an example of a schematic configuration of an internal information acquisition system.

FIG. 21 is a diagram illustrating an example of a schematic configuration of an endoscopy surgery system.

FIG. 22 is a block diagram illustrating an example of a functional configuration of a camera head and a CCU.

FIG. 23 is a block diagram illustrating an example of a schematic configuration of a vehicle control system.

FIG. 24 is an explanatory diagram illustrating examples of mounting positions of a vehicle exterior information detector and image capture units.

FIG. 25 is a diagram showing the outline of a configuration example of a stacked-type solid-state imaging apparatus to which the technology according to the present disclosure can be applied.

FIG. 26 is a cross-sectional view showing a first configuration example of a stacked-type solid-state imaging apparatus 23020.

FIG. 27 is a cross-sectional view showing a second configuration example of the stacked-type solid-state imaging apparatus 23020.

FIG. 28 is a cross-sectional view showing a third configuration example of the stacked-type solid-state imaging apparatus 23020.

FIG. 29 is a cross-sectional view showing another configuration example of the stacked-type solid-state imaging apparatus to which the technology according to the present disclosure can be applied.

### DESCRIPTION OF EMBODIMENTS

Hereinafter, favorable embodiments of the present disclosure will be described in detail with reference to the accompanying drawings. It should be noted that the components having substantially the same functional configuration will be denoted by the same reference symbols, and duplicate description will be omitted herein and in the drawings.

Further, the description will be given in the following order.

1. First Embodiment

2. Second Embodiment

3. Third Embodiment

4. Fourth Embodiment

5. Fifth Embodiment

6. Sixth Embodiment

7. Seventh Embodiment

8. Eighth Embodiment

9. Regarding Configuration of CSP Solid-State Imaging Element

10. Example of Application to Electronic Apparatuses

11. Usage Example of Imaging Apparatus

12. Example of Application to Internal Information Acquisition System

13. Example of Application to Endoscopic Operation System

14. Example of Application to Movable Object

15. Configuration Example of Stacked-Type Solid-State Imaging Apparatus to Which Technology According to Present Disclosure Can Be Applied

### 1. First Embodiment

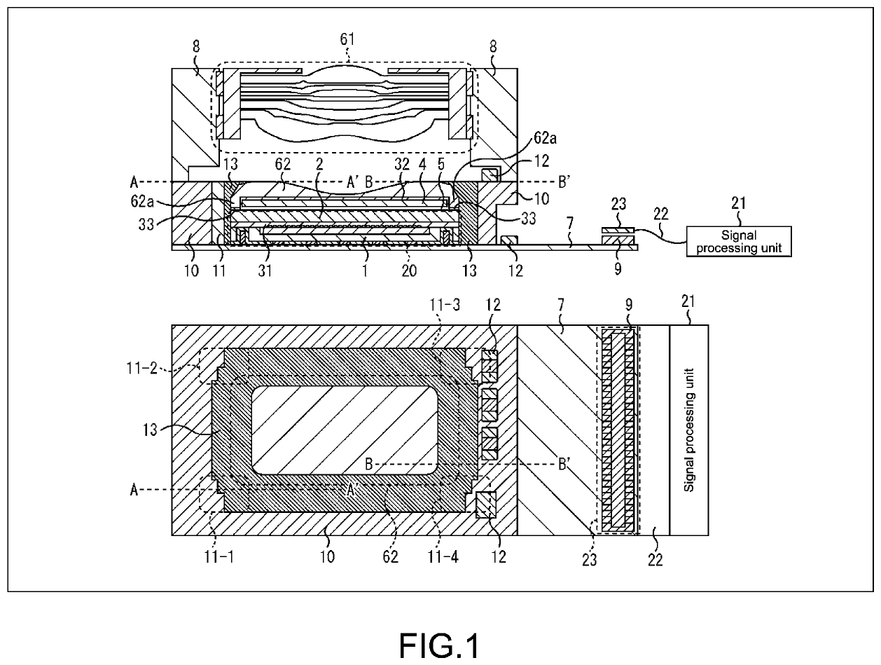

FIG. 1 is a diagram illustrating a structure of an imaging apparatus to which a solid-state imaging element according to a first embodiment of the present disclosure is applied. An upper part of FIG. 1 is a cross-sectional side view of the imaging apparatus, and a lower part of FIG. 1 is a top view of a cross section taken along the line AB′ in the upper part. Note that the left half of the upper part of FIG. 1 illustrates a cross section taken along the line AA′ in the lower part, and the right half of the upper part of FIG. 1 illustrates a cross section taken along the line BB′ in the lower part.

The imaging apparatus illustrated in FIG. 1 includes a CSP (Chip Size Package) solid-state imaging element 20, a circuit substrate 7, an actuator 8, a spacer 10, and lenses 61 and 62. Although one lens 62 is shown, it should be understood that lens 62 may be comprised of multiple lenses or lens layers. The lenses in the imaging apparatus illustrated in FIG. 1 are divided into two groups consisting of the lenses 61 and 62, and arranged, in the light transmission direction, from the lens 61 in the upper layer to the lens 62 in the lowermost layer placed right above a solid-state imaging element 1.

The CSP (Chip Size Package) solid-state imaging element 20 illustrated in FIG. 1 is an imaging element in which the solid-state imaging element 1, a glass substrate (or transparent substrate) 2, an infrared cut filter (or transparent substrate) 4, and the lens 62 are formed as an integrated structure.

In more detail, the solid-state imaging element 1 is, for example, a CCD (Charged Coupled Devices) image sensor or a CMOS (Complementary Metal Oxide Semi-conductor) image sensor. The solid-state imaging element 1 generates charges by photoelectrically converting, according to the amount of light, light entering the solid-state imaging element 1 via the lens 6 constituted of the integrated lenses 61 and 62, and outputs a pixel signal including an electric signal corresponding thereto. The solid-state imaging element 1 and the glass substrate 2 are adhered to each other by a transparent adhesive 31. The lens 62 in the lowermost layer includes a convex portion 62a protruding in a lower direction of the figure in a peripheral portion, and is adhered to the glass substrate 2 by an adhesive 33. Further, the infrared cut filter 4 that is a filter that cuts infrared light is adhered by a transparent adhesive 32 at the bottom of the lens 62 in the lowermost layer in the figure, on a rear side in the light transmission direction, excluding the convex portion 62a in the peripheral portion. A cavity layer 5 is provided between the infrared cut filter 4 and the glass substrate 2. Specifically, excluding the convex portion 62a provided in the peripheral portion of the lens 62, the lens 62, the adhesive 32, the infrared cut filter 4, the cavity layer 5, the glass substrate 2, the adhesive 31, and the solid-state imaging element 1 are stacked in the stated order from above in the figure.

Since the CSP solid-state imaging element 20 is configured as illustrated in FIG. 1, the CSP solid-state imaging element 20 is treated as one component in an assembly step.

When regarding the two groups including the lenses 61 and 62 constituting the lens 6 as one optical system, the lens 61 constitutes one of the two groups, and includes one or more lenses for condensing object light on the imaging surface of the solid-state imaging element 1.

The actuator 8 has at least one of functions of an autofocus function and a camera shake correction function, i.e., drives the lens 61 in the vertical direction and the horizontal direction in FIG. 1 with respect to the direction facing the solid-state imaging element 1.

The circuit substrate 7 outputs the electric signal of the CSP solid-state imaging element 20 to the outside. The spacer 10 is fixed by being connected to a fixing agent (or light absorbing material) 13 formed of, for example, black resin that absorbs light from the circuit substrate 7 and the CSP solid-state imaging element 20. Further, the spacer 10 fixes the lens 61 and the actuator 8 by mounting the actuator 8 on the upper surface part thereof illustrated in FIG. 1.

On the circuit substrate 7 and the spacer 10, semiconductor components 12 such as a capacitor and an actuator control LSI (Large-Scale Integration) necessary for driving the solid-state imaging element 1 and the actuator 8 of the CSP solid-state imaging element 20 are mounted. Here, it should be understood that a collection of various elements in FIG. 1 (and other figures) may be referred to as an imaging structure. For example, the imaging structure may include the CSP solid-state imaging element 20 (including solid-state imaging element 1), the lenses 61 and 62, the cavity layer 5, the infrared cut filter 4, the glass substrate 2, the actuator 8, and any adhesive elements that hold these elements together (e.g., 13, 31, 32, 33). Said another way, the imaging structure may exclude the circuit substrate 7, the connector 9, external terminal 23, the signal processing unit 21, the spacer 10, and semiconductor elements 12.

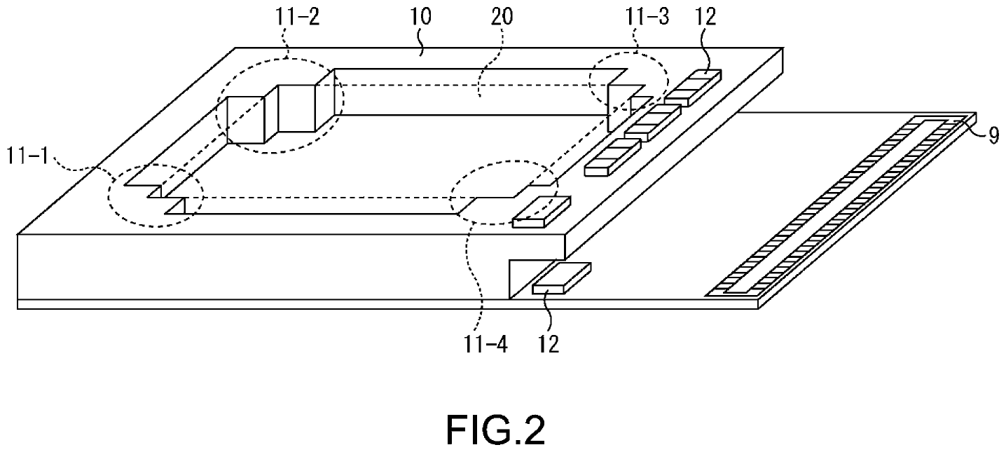

Further, as illustrated in FIG. 2, four corners of the CSP solid-state imaging element 20 are to be fitted into fixing portions 11-1 to 11-4 provided in the spacer 10. Only by fitting the four corners, the CSP solid-state imaging element 20 can be guided and fixed to a substantially appropriate position on the circuit substrate 7 only with the action of gravity even before injecting the fixing agent 13 into the circuit substrate 7. In other words, the fixing portions 11-1 to 11-4 are formed in the spacer 10 so that the four corners of the CSP solid-state imaging element 20 are guided to an appropriate position on the circuit substrate 7 when the CSP solid-state imaging element 20 is fitted into the opening of the spacer 10.

Note that the fixing portions 11-1 to 11-4 are formed to have a size that slight space is generated between the fixing portions 11-1 to 11-4 and the CSP solid-state imaging element 20 in the range in which the CSP solid-state imaging element 20 is allowed to intersect with the fixing portions 11-1 to 11-4 when the CSP solid-state imaging element 20 is placed at an appropriate position of the opening of the spacer 10. However, the fixing portions 11-1 to 11-4 have a structure for suppressing inclination and displacement of the CSP solid-state imaging element 20 due to warpage, distortion, or contraction thereof by coming into contact with the CSP solid-state imaging element 20 to guide the CSP solid-state imaging element 20 to an appropriate position when warpage, distortion, contraction, or the like of the CSP solid-state imaging element 20 is about to occur.

Therefore, by placing the CSP solid-state imaging element 20 on the spacer 10 so that the four corners are fitted into the fixing portions 11-1 to 11-4, the CSP solid-state imaging element 20 can be guided to and placed at an appropriate position on the circuit substrate 7 by the fixing portions 11-1 to 11-4, under the action of gravity by its own weight.

Further, after the CSP solid-state imaging element 20 is guided to and placed at an appropriate position on the circuit substrate 7, the position of the CSP solid-state imaging element 20 is not displaced even when injecting the fixing agent 13 into space between the CSP solid-state imaging element 20 and the spacer 10. Therefore, even when, for example, the fixing agent 13 is deformed before the fixing agent 13 is dried and fixed (cured), it is possible to suppress distortion, warpage, and inclination of the CSP solid-state imaging element 20 with respect to the circuit substrate 7.

Note that the spacer 10 may have a circuit configuration similar to that of the circuit substrate 7. Further, it is desirable that the material of the circuit substrate 7 is a material similar to (having a linear expansion coefficient similar to that of) silicon that is the material of the solid-state imaging element 1, or a material having a low elastic modulus lower than a predetermined elastic modulus.

Further, the actuator 8 may have at least one of an autofocus function and a camera shake correction function, or may be a fixed-focal lens holder.

Further, the autofocus function and the camera shake correction function may be realized by means other than the actuator.

A connector 9 externally outputs an image signal output by the solid-state imaging element 1, via the circuit substrate 7. The connector 9 is connected to an external terminal 23, and outputs the image signal to a signal processing unit 21 via a cable 22. The signal processing unit 21 corrects the image signal in a manner that depends on needs, converts the image signal into a predetermined compression format, and outputs the converted image signal.

<Example in Case where Infrared Cut Filter is Provided in Upper Layer Lens and Cavity Layer is not Provided>

For describing effects in the imaging apparatus illustrated in FIG. 1, which are provided by stacking the lens 62, the adhesive 32, the infrared cut filter 4, the cavity layer (or air cavity) 5, the glass substrate 2, the adhesive 31, and the solid-state imaging element 1 in the stated order, an example in the case where the infrared cut filter 4 is provided on the side of the lens (or lens stack) 61 and the cavity layer 5 is not provided will be described.

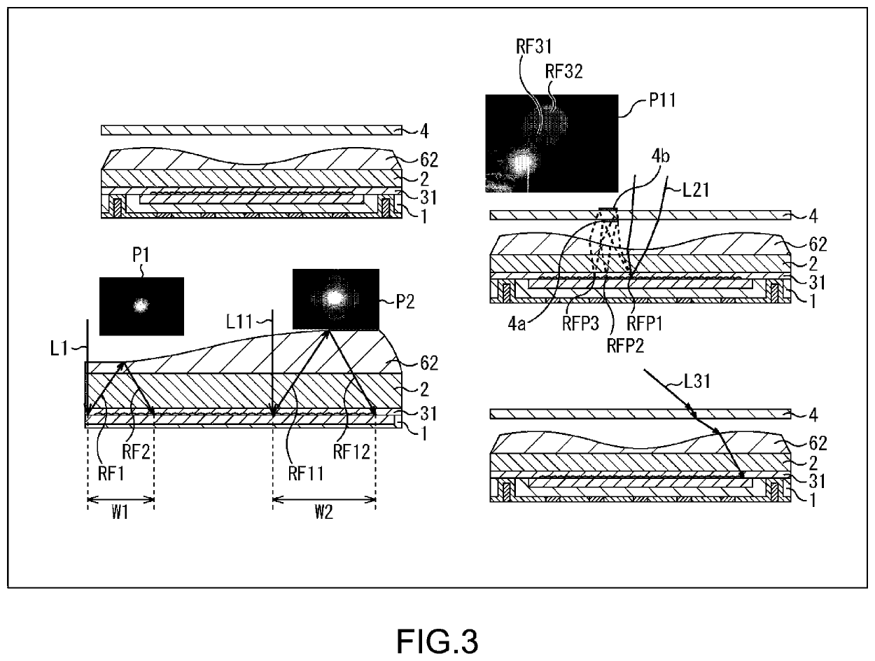

In the case where the infrared cut filter 4 is provided on the side of the upper layer lens 61 and the cavity layer 5 is not provided, a configuration illustrated in the upper left part of FIG. 3 is provided. Note that, in FIG. 3, the infrared cut filter 4 is provided on the side of the upper layer lens 61 (not shown). Further, the glass substrate 2 is provided just below the lens 62 in the lowermost layer, and the glass substrate 2 and the solid-state imaging element 1 are adhered to each other by the transparent adhesive 31.

Here, it is assumed that the lens 62, the glass substrate 2, and the adhesive 31 all have an identical refractive index. Then, it is obvious that the refractive index of the solid-state imaging element 1 is higher than the refractive index of the lens 62, the glass substrate 2, and the adhesive 31.

Thus, as illustrated in the lower left part of FIG. 3, a light flux of intense light entering the solid-state imaging element 1 through the lens 61 in the upper layer experiences reflection called total reflection due to a difference between the refractive index of the solid-state imaging element 1 and the refractive index of the adhesive 31 just before it enters. The totally-reflected component is further reflected due to a refractive index difference between the lens 62 in the lowermost layer and the air, and re-enters the solid-state imaging element 1. Hereinafter, the component of the incident light, which is totally reflected by the solid-state imaging element 1, will be also referred to as a totally-reflected component of the incident light, and the light that is reflected on the upper surface of the lens 62 in the lowermost layer and re-enters the solid-state imaging element 1 will be referred to as a totally-reflected and turned-back component of the incident light.

By the way, the thickness of the lens 62 concentrically varies in a manner that depends on a distance from the central position of the lens 62. Therefore, in a manner that depends on an incident position of incident light from the central position of the lens 62, an incident position of a corresponding totally-reflected and turned-back component varies.

In more detail, as illustrated in the lower left part of FIG. 3, when incident light L1 enters the solid-state imaging element 1, part thereof is reflected as a totally-reflected component RF1, is reflected at the boundary between the lens 62 and an air layer, and re-enters the solid-state imaging element 1 as a totally-reflected and turned-back component RF2, for example.

On the other hand, when incident light L11 enters the solid-state imaging element 1, part thereof is reflected as a totally-reflected component RF11, is reflected at the boundary between the lens 62 and the air layer, and re-enters the solid-state imaging element 1 as a totally-reflected and turned-back component RF12, for example.

Specifically, regarding a distance W1 between an incident position of the incident light L1 and a position of re-incidence of light (second-incident position) as the totally-reflected and turned-back component RF2 and a distance W2 between an incident position of the incident light L11 and a second-incident position of the totally-reflected and turned-back component RF12, the distance W2 is larger than the distance W1. Therefore, the captured image formed by the incident light L1 and the totally-reflected and turned-back component RF2 is, for example, an image P1. Meanwhile, the captured image formed by the incident light L11 and the totally-reflected and turned-back component RF12 is, for example, an image P2. As a result, the size of an image of an object in the image P1 and the size of an image of an object in the image P2 are different due to displacements generated with respect to an identical image.

Specifically, regarding an image generated by the totally-reflected component RF1 and the totally-reflected and turned-back component RF2 and an image generated by the totally-reflected component RF11 and the totally-reflected and turned-back component RF12, displacement widths between the generated images are different due to light-path differences thereof.

Therefore, for correcting the displacement of the image generated by the totally-reflected and turned-back component included in the captured image, the signal processing unit 21 needs to perform different types of processing in a manner that depends on the lens shape and the distance from the central position of the lens. However, the lens shape and the correction processing by the signal processing unit 21 considering variations in the lens shape and the like can result in complicated correction-related processing and an increase in processing time.

Further, as illustrated in the upper right part of FIG. 3, incident light L21 passes through the infrared cut filter 4, and then, passes through the lens 62, the glass substrate 2, and the adhesive 31. When the incident light L21 enters the solid-state imaging element 1 at a focal point RFP1, totally-reflected components as part of the reflection light are reflected on a lower surface 4a and an upper surface 4b of the infrared cut filter 4 in the figure. Thus, the totally-reflected components re-enter the solid-state imaging element 1 at focal points RFP2 and RFP3 as totally-reflected and turned-back components, respectively.

As a result, for example, as shown in an image P11, reflection images RF31 and RF32 are generated by re-incidence at the focal points RFP2 and RFP3, with respect to an image formed by incidence at the original focal point RFP1.

In addition, as illustrated in the lower right part of FIG. 3, it is general to use a technique of increasing the angle of light entering the lens 62 in the lowermost layer for downsizing the solid-state imaging element 1 in recent years. However, the infrared cut filter 4 has a lower infrared cut property against incidence of oblique light and it is difficult to ensure the performance at a predetermined angle or more, which may make it difficult to realize downsizing, particularly, reduction in height.

<Effect of Configuration in Which Infrared Cut Filter of Imaging Apparatus Illustrated in FIG. 1 is Arranged in Rear of Lowermost Layer Lens and Cavity Layer is Provided>

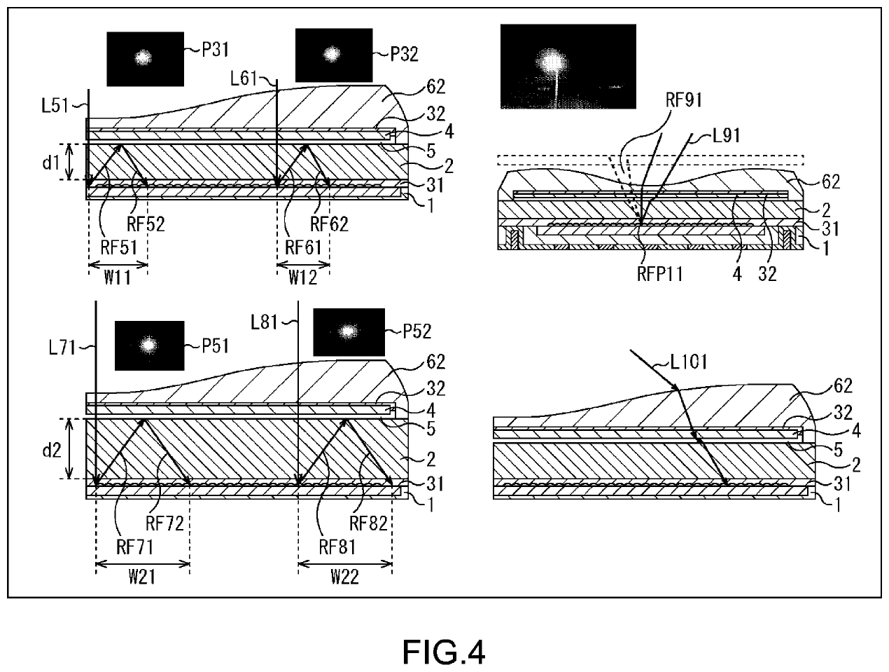

Next, an effect of the configuration in the imaging apparatus illustrated in FIG. 1 in which the infrared cut filter of the imaging apparatus illustrated in FIG. 1 is arranged in the rear of the lowermost layer lens and the cavity layer is provided will be described with reference to FIG. 4.

By providing a cavity layer (gap) 5 between the glass substrate 2 and the infrared cut filter 4 adhered by the adhesive 31 to the surface of the lens 62 in the lowermost layer, on the lower side in the figure, in the imaging apparatus illustrated in FIG. 1, an air layer having a small distance between the CSP solid-state imaging element 20 and the lens 62 in the lowermost layer is ensured.

Due to this cavity layer 5 including the air layer, the totally-reflected component is reflected as the totally-reflected and turned-back component at the boundary between the cavity layer 5 including the air layer and the glass substrate 2, and re-enters the solid-state imaging element 1.

For example, as illustrated in the upper left part of FIG. 4, with an imaging apparatus formed of the glass substrate 2 having a thickness d1, when incident light L51 near the central position of the lens 62 enters the solid-state imaging element 1, part thereof is reflected as a totally-reflected component RF51, is reflected at the boundary between the lens 62 and the cavity layer 5 that is the air layer, and re-enters the solid-state imaging element 1 as a totally-reflected and turned-back component RF52, for example.

Further, when incident light L61 far from the central position of the lens 62 enters the solid-state imaging element 1, part thereof is reflected as a totally-reflected component RF61, is reflected at the boundary between the lens 62 and the cavity layer 5 including the air layer, and re-enters the solid-state imaging element 1 as a totally-reflected and turned-back component RF62, for example.

Regarding a distance W11 between an incident position of the incident light L51 and a second-incident position of the totally-reflected and turned-back component RF52 and a distance W12 between an incident position of the incident light L61 and a second-incident position of the totally-reflected and turned-back component RF62, the light paths are substantially identical, and hence the displacements of generated images are substantially identical.

Therefore, the captured image formed by the incident light L51 and the totally-reflected and turned-back component RF52 is, for example, an image P31. Meanwhile, the captured image formed by the incident light L61 and the totally-reflected and turned-back component RF62 is, for example, an image P32. As a result, the displacements generated with respect to the identical image are substantially identical in the image P31 and the image P32.

On the other hand, for example, as illustrated in the lower left part of FIG. 4, with an imaging apparatus formed of the glass substrate 2 having a thickness d2 (>d1), when incident light L71 near the central position of the lens 62 enters the solid-state imaging element 1, part thereof is reflected as a totally-reflected component RF71, is reflected at the boundary between the lens 62 and the cavity layer 5 including the air layer, and re-enters the solid-state imaging element 1 as a totally-reflected and turned-back component RF72, for example.

Further, when incident light L81 far from the central position of the lens 62 enters the solid-state imaging element 1, part thereof is reflected as a totally-reflected component RF81, is reflected at the boundary between the lens 62 and the cavity layer 5 including the air layer, and re-enters the solid-state imaging element 1 as a totally-reflected and turned-back component RF82, for example.

Regarding a distance W21 between an incident position of the incident light L71 and a second-incident position of the totally-reflected and turned-back component RF72 and a distance W22 between an incident position of the incident light L81 and a second-incident position of the totally-reflected and turned-back component RF82, the light paths are substantially identical, and hence the displacements of generated images are substantially identical.

Therefore, the captured image formed by the incident light L71 and the totally-reflected and turned-back component RF72 is, for example, an image P51. Meanwhile, the captured image formed by the incident light L81 and the totally-reflected and turned-back component RF82 is, for example, an image P52. As a result, the displacements generated with respect to the identical image are substantially identical in the image P51 and the image P52.

Specifically, the totally-reflected component is turned back at the boundary with the cavity layer 5 including the air layer on the glass substrate 2, and re-enters the solid-state imaging element 1 as the totally-reflected and turned-back component. The difference between the incident light to the solid-state imaging element 1 and the totally-reflected and turned-back component becomes a constant displacement in the imaging surface of the solid-state imaging element. Therefore, the difference between the incident light to the solid-state imaging element 1 and the totally-reflected and turned-back component is substantially constant in the imaging surface of the solid-state imaging element 1. Thus, the processing load related to the correction of the signal processing unit 21 can be reduced.

Further, as illustrated in the upper left part and the lower left part of FIG. 4, the light path of the totally-reflected component (RF51 or RF61) and the totally-reflected and turned-back component (RF52 or RF62) in the glass substrate 2 having the thickness d1 is shorter than the light path of the totally-reflected component (RF71 or RF81) and the totally-reflected and turned-back component (RF72 or RF72) in the glass substrate 2 having the thickness d2. Therefore, the distance W11 or W12 that is a displacement between the incident position of the incident light L51 or L61 and the incident position of the totally-reflected and turned-back component (RF52 or RF62) in the glass substrate 2 having the thickness d1 is shorter than the distance W21 or W22 that is a displacement between the incident position of the incident light L71 or L81 and the incident position of the totally-reflected and turned-back component (RF72 or RF82) in the glass substrate 2 having the thickness d2.

Specifically, as the thickness of the glass substrate 2 becomes smaller, i.e., as the light path difference between the totally-reflected and turned-back component and the totally-reflected component becomes smaller, it is possible to reduce the distance that is the displacement between the incident position of the incident light and the incident position of the totally-reflected and turned-back component, it is difficult to see the displacement of the image, and the processing load related to the correction of the signal processing unit 21 can be reduced. Therefore, if the thickness of the glass substrate 2 can be reduced such that the displacement of the image is sufficiently smaller than a predetermined value, it is also possible to omit the correction processing by the signal processing unit 21 in a manner that depends on needs.

In addition, as illustrated in the upper right part of FIG. 4, in the imaging apparatus illustrated in FIG. 1, the infrared cut filter 4 is provided between the lens 62 in the lowermost layer and the solid-state imaging element 1. In the case where the infrared cut filter 4 is provided in front of the lens 62 as illustrated by dotted lines, incident light L91 enters a focal point RFP11 and then is reflected by the infrared cut filter 4 as a reflected component RF91. However, since the turned-back component of the reflected component RF91 is generated, the displacement of the image due to the turned-back component is not generated. Thus, as shown in an image P61, the influence due to the reflection as in the image P11 of FIG. 3 is not provided.

Further, as illustrated in the lower right part of FIG. 4, even if a light beam enters at an acute angle with respect to a direction perpendicular to the solid-state imaging element 1 for downsizing and reduction in height of the imaging apparatus 1, the angle of incidence is corrected in the lens 62 in the lowermost layer, the angle becomes smaller, and light having the smaller angle passes through the infrared cut filter 4, Therefore, the angle of incidence becomes smaller, and it can contribute to downsizing and reduction in height of the solid-state imaging element 1 without deteriorating the characteristics of the infrared cut filter 4.

<Effect of Suppressing Occurrence of Flare in Imaging Apparatus Illustrated in FIG. 1>

Next, an effect of suppressing occurrence of a flare in the imaging apparatus illustrated in FIG. 1 will be described. The imaging apparatus illustrated in FIG. 1 uses the fixing agent 13 including a light absorbing material such as black resin that absorbs light to cover the entire periphery of the side surface including the peripheral portion of the incident surface of incident light of the lens 62, the infrared cut filter 4, the solid-state imaging element 1, the glass substrate 2, and the adhesives 31 and 32 in order to suppress the above-mentioned flare phenomenon caused due to the displacement of the image. Therefore, the influence due to the flare phenomenon is reduced.

Further, by using the fixing agent 13 having black color or the like, which absorbs light, to fill the space up to the spacer 10 while covering the entire periphery of the side surface of the CSP solid-state imaging element 20, even in the case where incident light is reflected on the spacer 10, the reflected light is absorbed, so that the reflection is suppressed. As a result, it is possible to suppress occurrence of a flare phenomenon due to diffused reflection of light from the spacer 10. Note that it is desirable to use, as the fixing agent 13 formed of a light absorbing material such as black resin that absorbs light, one having a reflectance of not more than 5%, for example.

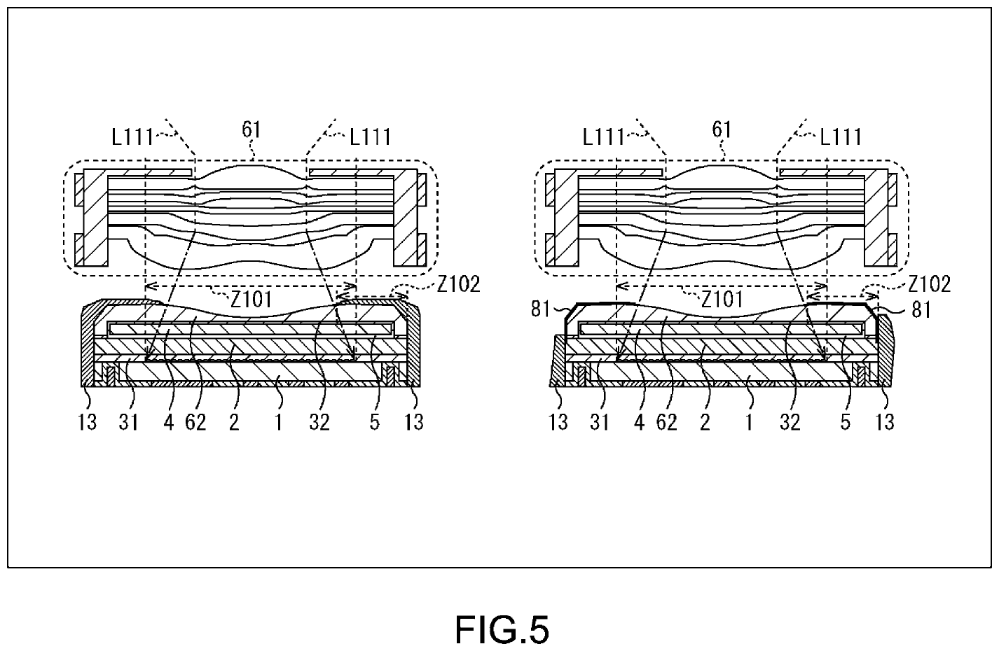

Note that in the imaging apparatus illustrated in FIG. 1, the fixing portions 11 for correcting the inclination of the glass substrate 2 and the solid-state imaging element 1 are provided to the spacer 10 in order to prevent the CSP solid-state imaging element 20 from being inclined. In the case where it is difficult to fill the fixing agent 13 formed of a light absorbing material such as black resin that absorbs light between the CSP solid-state imaging element 20 and the fixing portions 11 for correcting the inclination, it is possible to achieve the same effect by performing, in advance, processing (mask processing) of applying a mask (that is the same as a mask 81 to be described with reference to FIG. 5) formed of a black light absorbing material to the walls (surfaces) of the fixing portions 11 for correcting the inclination.

Specifically, a mask processing of applying a mask formed of a black light absorbing material to the surfaces of the fixing portions 11 of the spacer 10 for correcting the inclination of the glass substrate and the solid-state imaging element may be performed. With this, the influence due to the flare phenomenon is reduced.

An example in which the fixing agent 13 formed of a light absorbing material such as black resin that absorbs light is provided so as to cover the entire periphery of the side surface of the CSP solid-state imaging element 20 or a mask formed of a black light absorbing material that absorbs light is applied to the walls (surfaces) of the fixing portions 11 has been described. However, in the imaging apparatus illustrated in FIG. 1, the light absorbing material of any one of the fixing agent 13 and the mask is provided to shield not only the entire periphery of the side surface of the CSP solid-state imaging element 20 but also a part of the incident surface of the lens 62 in the lowermost layer on which incident light is to be incident.

Specifically, as illustrated in the upper left part of FIG. 5, in the case of embedding the fixing agent 13 formed of a light absorbing material such as black resin into the periphery of the CSP solid-state imaging element 20, the fixing agent 13 is embedded (applied) so as to cover a mask area Z102 that is an area other than the area in which incident light enters the CSP solid-state imaging element 20 within an effective pixel area Z101 as illustrated in a light path L111 of light condensed by the lens 62.

Specifically, a light beam from the lens 62 that enters the effective pixel area Z101 generally enters pixels in the effective pixel area Z101 of the CSP solid-state imaging element 20 at an acute angle from the outside, which may cause a flare phenomenon to occur. In this regard, as illustrated in the left part of FIG. 5, the fixing agent 13 formed of a light absorbing material such as black resin is embedded into (applied to) the area up to the outer peripheral portion of the lens 62 in the lowermost layer in a mask area Z102 that is the outer peripheral portion of the lens 62 in the lowermost layer.

Note that the size of the mask area Z102 surrounding the outer peripheral portion of the lens 62 in the lowermost layer is calculated on the basis of design values of the upper layer lens 61 and the microlens of the pixel of the CSP solid-state imaging element 20.

Further, the mask area Z102 including the periphery of the side surface of the CSP solid-state imaging element 20 and the outer peripheral portion of the lens 62 may include the mask 81 formed of, for example, not the fixing agent 13 but a black light absorbing material as illustrated in the right part of FIG. 5. Also with such a configuration, it is possible to suppress occurrence of a flare phenomenon.

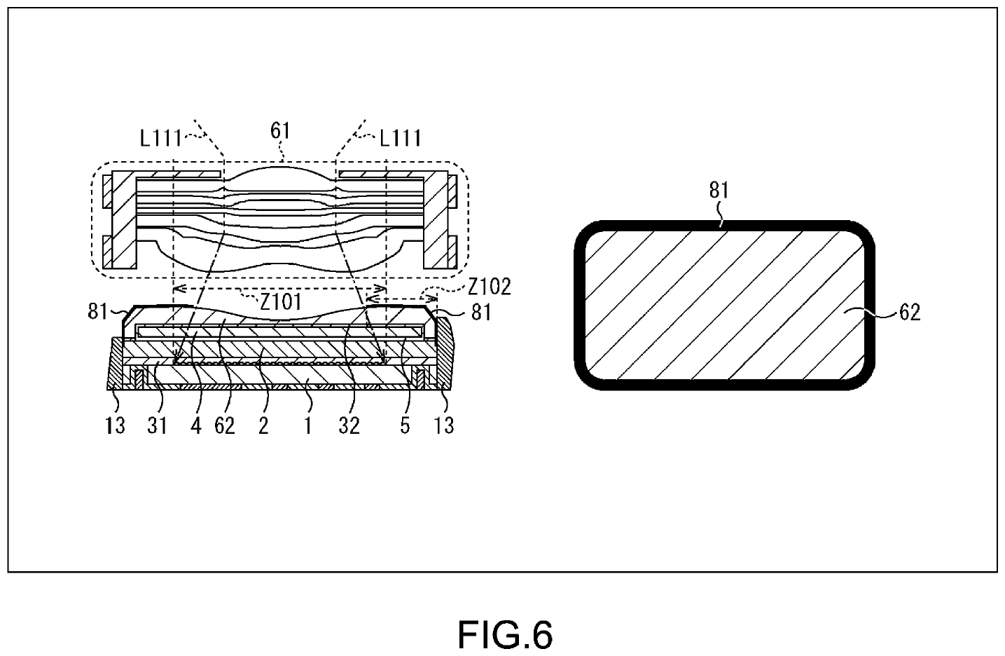

Further, as illustrated in the left part of FIG. 6, the fixing agent 13 may be embedded into the periphery of the side surface of the CSP solid-state imaging element 20, and the mask 81 may be formed in the mask area Z102 on the lens 62.

Meanwhile, in the case of applying the fixing agent 13 formed of a light absorbing material such as black resin to the area up to the mask area Z102 of the lens 62 in the lowermost layer with high accuracy by a coating apparatus at the time of production of a solid-state imaging apparatus, there is a possibility that the coating apparatus becomes expensive or a high degree of control is necessary, which increases the cost in any case.

In this regard, as illustrated in the right part of FIG. 6, by performing mask processing on only the mask area Z102 of the lens 62 in the lower most layer to form the mask 81 in advance, it is possible to reduce the necessary accuracy of application of the fixing agent 13 formed of a light absorbing material such as black resin at the time of production of a solid-state imaging apparatus. As a result, it is possible to reduce the necessary accuracy and the degree of difficulty of control regarding the coating apparatus, which reduces the cost.

Note that the mask 81 may be applied directly to the lens 62 itself in the lowermost layer before the lens 62 is formed in the CSP solid-state imaging element 20. Alternatively, the mask 81 may be applied to the lens 62 in the lowermost layer after the lens 62 is formed in the CSP solid-state imaging element 20.

<Manufacturing Method for Imaging Apparatus>

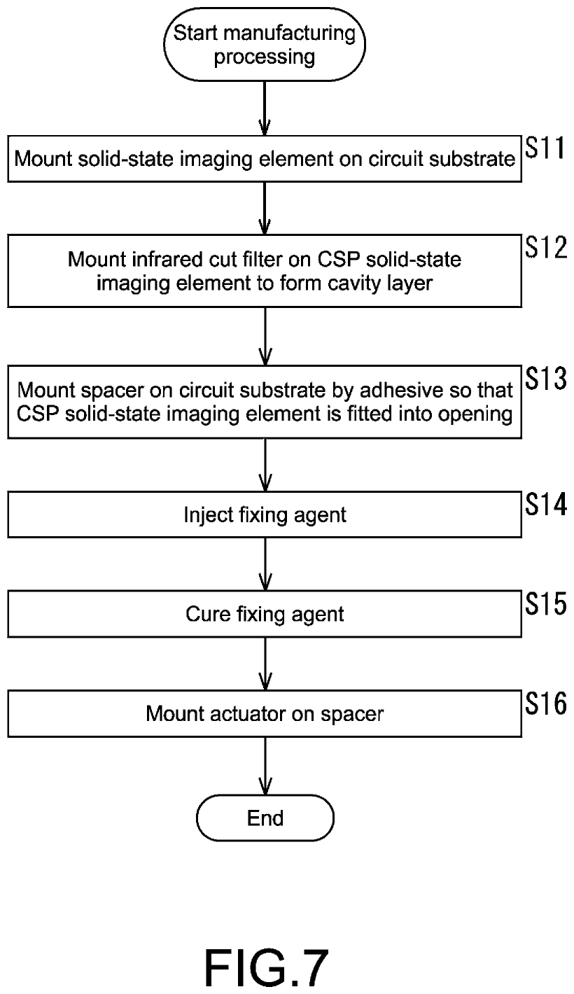

Next, a manufacturing method for the imaging apparatus illustrated in FIG. 1 will be described with reference to the flowchart of FIG. 7.

In Step 11, the CSP solid-state imaging element 20 is mounted on the circuit substrate 7.

In Step S12, the lens 62 to which the infrared cut filter 4 is adhered by the adhesive 32 is adhered to and mounted on the CSP solid-state imaging element 20 via the adhesive 33 applied to the convex portion 62a. Specifically, with this processing, the lens 62 including the infrared cut filter 4 is mounted on the CSP solid-state imaging element 20 via the cavity layer 5.

In Step S13, the spacer 10 is mounted on the circuit substrate 7 by an adhesive in the state where the four corners of the CSP solid-state imaging element 20 on which the lens 62 including the infrared cut filter 4 is mounted are fitted into the fixing portions 11-1 to 11-4 of the spacer 10 so as to be guided to appropriate positions on the circuit substrate 7. As a result, the CSP solid-state imaging element 20 is guided by the fixing portions 11-1 to 11-4 and placed at an appropriate position on the circuit substrate 7 where electrical connection is possible, under the action of gravity by its own weight, even on the thin circuit substrate 7 in which deflection and the like are likely to occur.

In Step S14, the fixing agent 13 formed of a light absorbing material such as black resin that absorbs light for suppressing reflection of light from the side (periphery of the side surface) is injected into space between the CSP solid-state imaging element 20 and the spacer 10 in order to suppress a flare phenomenon due to diffused reflection of light. In Step S15, the fixing agent 13 is cured (fixed). Note that the fixing agent 13 is applied to the area from the bottom portion of the CSP solid-state imaging element 20 to the outer peripheral portion of the lens 62 to suppress reflection of light from the side (periphery of the side surface). As a result, the CSP solid-state imaging element 20, the spacer 10, and the circuit substrate 7 are fixed via the fixing agent 13. Since the state where the CSP solid-state imaging element 20 is placed at an appropriate position by the fixing portions 11-1 to 11-4 is kept until the fixing agent 13 is fixed after the fixing agent 13 is injected, the CSP solid-state imaging element 20 is appropriately fixed without causing distortion, warpage, and inclination to occur.

In Step S16, the actuator 8 is mounted on the spacer 10.

In the case of using the mask 81, it is necessary to perform a process of applying the mask 81 to the walls (surfaces) of the fixing portions 11 in advance.

Further, in the case of applying the mask 81 to the outer peripheral portion of the lens 62 in the lowermost layer, it is necessary to perform a process of applying the mask 81 to the outer peripheral portion of the lens 62 in the lowermost layer.

By the series of manufacturing methods described above, it is possible to fix the CSP solid-state imaging element 20 by the fixing agent 13 in the state where the CSP solid-state imaging element 20 is placed at an appropriate position on the thin circuit substrate 7 in which deflection is likely to occur.

Further, the lens 62 including the infrared cut filter 4 is formed in the state where the cavity layer 5 including the air layer is formed in front of the CSP solid-state imaging element. Therefore, the displacement between the incident position of the incident light and the incident position of the totally-reflected and turned-back component becomes substantially identical irrespective of the thickness of the lens 62, i.e., irrespective of the distance from the central position of the lens 62. Therefore, the processing load in correcting the displacement between the incident position of the incident light and the incident position of the totally-reflected and turned-back component by the signal processing unit 21 can be reduced, and high-speed, lower-power processing can be realized.

Note that, by reducing the thickness of the glass substrate 2, the displacement between the incident light and the totally-reflected and turned-back component can be made smaller. Therefore, the processing load of the signal processing unit 21 can be further reduced. Further, if the thickness of the glass substrate 2 can be adjusted such that the displacement between the incident position of the incident light and the incident position of the totally-reflected and turned-back component is made extremely small, the correction processing for the displacement between the incident position of the incident light and the incident position of the totally-reflected and turned-back component in the signal processing unit 21 may be omitted.

Further, it is possible to suppress deterioration of the yield and optical performance of the imaging apparatus, and realize a high-performance, small-sized, and thin imaging apparatus capable of suppressing a flare phenomenon due to diffused reflection of light.

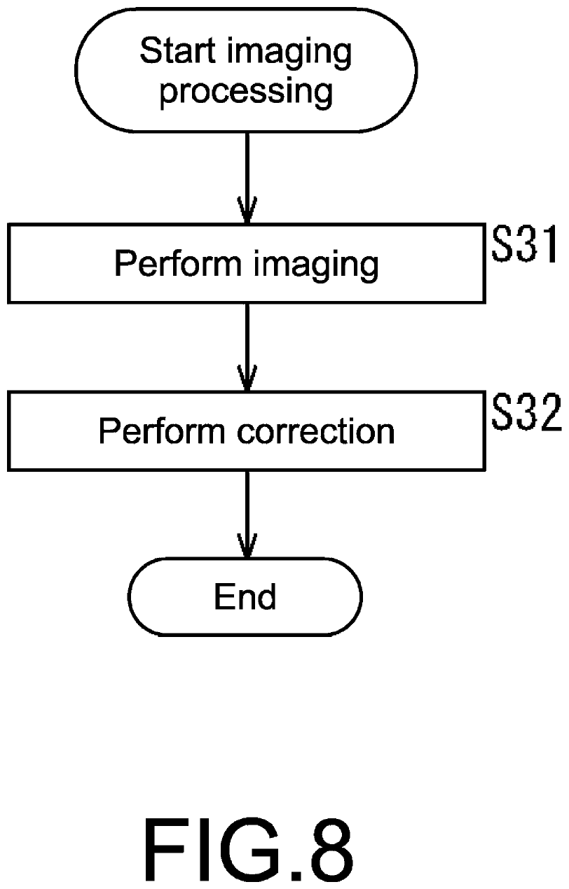

Next, imaging processing by the imaging apparatus illustrated in FIG. 1 will be described with reference to the flowchart of FIG. 8.

In Step S31, the CSP solid-state imaging element 20 generates an image signal formed of pixel signals corresponding to an amount of incident light entering via the lens 61, the lens 62, the adhesive 33, the infrared cut filter 4, and the cavity layer 5 including the air layer, which is adjusted by the actuator 8 to a predetermined focal point position or subjected to shake correction, and outputs the generated image signal to the signal processing unit 21 via the connector 9, the terminal 23, and the cable 22.

In Step S32, the signal processing unit 21 performs correction processing and encoding processing on the image signal supplied from the CSP solid-state imaging element 20, and externally outputs the image signal.

At this time, as described with reference to FIG. 4, due to the provision of the cavity layer 5, the signal processing unit 21 only needs to perform processing of correcting the displacement, which is fixed due to the thickness of the glass substrate 2, for correction of the displacement between the incident position of the incident light and the incident position of the totally-reflected and turned-back component. Therefore, the processing load can be reduced. Therefore, the speed of the correction processing can be increased and the power consumption related to the processing can be reduced.

Note that the CSP solid-state imaging element 20 illustrated in FIG. 1 may be replaced by a flip-chip solid-state imaging element having a flip-chip structure.

### 2. Second Embodiment

The example in which the infrared cut filter 4 is adhered to the lens 62 by the transparent adhesive 32 has been described above. However, by sandwiching the infrared cut filter 4 between the glass substrate 2 and the solid-state imaging element 1, the inexpensive infrared cut filter 4 may be used.

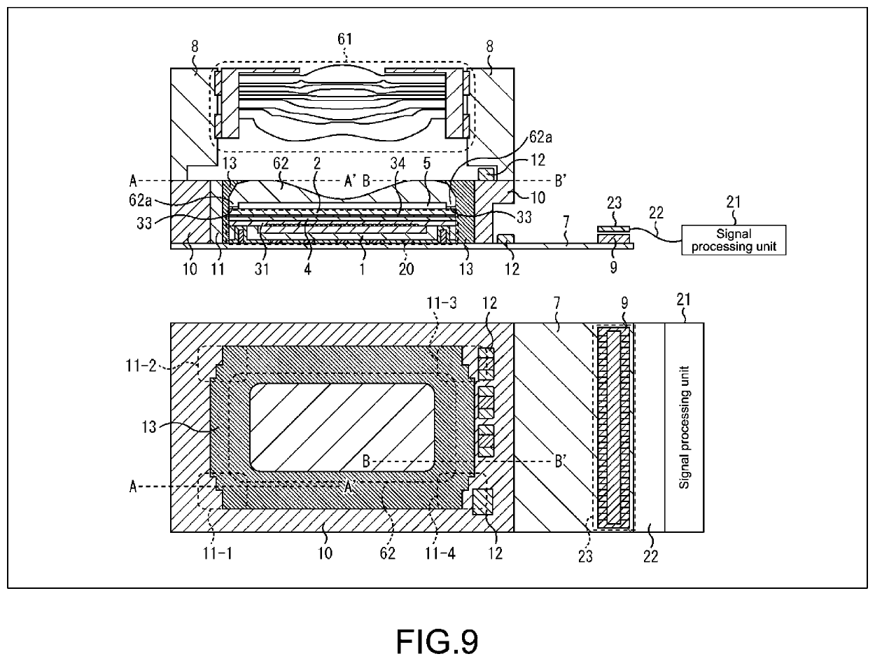

On the imaging apparatus illustrated in FIG. 9, the CSP solid-state imaging element 20 in which warpage and distortion of the infrared cut filter 4 are suppressed by sandwiching the infrared cut filter 4 between the glass substrate 2 and the solid-state imaging element 1 having small warpage and distortion in order to suppress warpage and distortion of the infrared cut filter 4 is mounted.

With such a configuration, even when using the inexpensive infrared cut filter 4 having relatively large warpage and distortion, by sandwiching the infrared cut filter 4 between the glass substrate 2 and the solid-state imaging element 1 having small warpage and distortion, warpage and distortion of the inexpensive infrared cut filter 4 can be physically suppressed. Therefore, it is possible to realize a small-sized and thin imaging apparatus having small optical warpage, distortion, and inclination at low cost, and suppress a flare phenomenon and a ghost phenomenon due to diffused reflection of light.

Further, by forming the cavity layer 5 on the front surface of the glass substrate 2, the displacement between the incident position of the incident light and the incident position of the totally-reflected and turned-back component, which depends on the distance from the central position of the lens 62, can be made substantially constant. Therefore, the processing load of the signal processing unit 21 can be reduced.

### 3. Third Embodiment

The example in which the cost is reduced by sandwiching the infrared cut filter 4 between the glass substrate 2 and the solid-state imaging element 1 has been described above. However, instead of the infrared cut filter 4, a material similar to the glass substrate 2, which can reduce infrared light, may be used.

Specifically, the glass substrate 2 serving as a key component of the imaging apparatus illustrated in FIG. 1 and FIG. 9 can be substituted for the infrared cut filter 4 having small warpage and distortion.

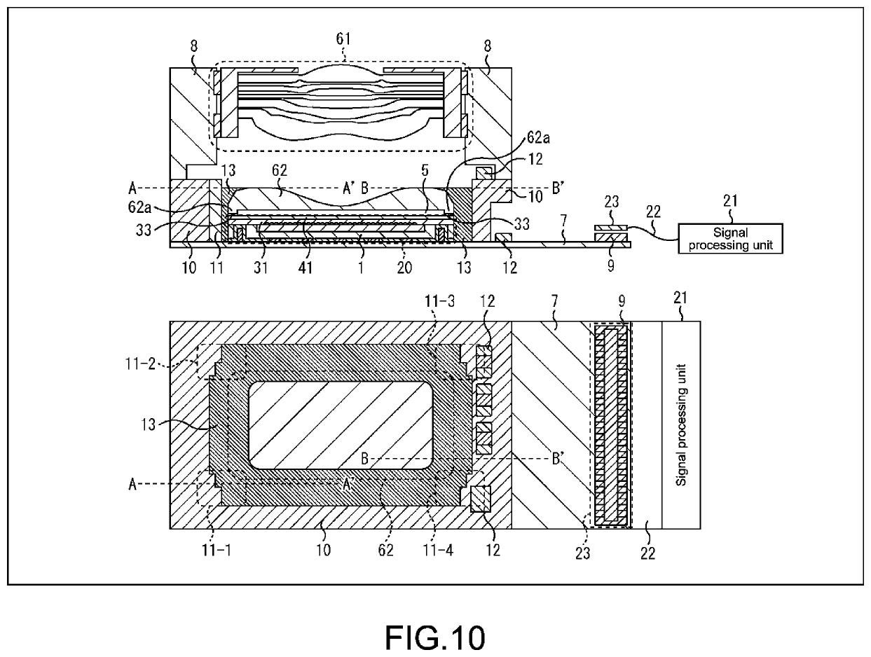

FIG. 10 illustrates a configuration example of the imaging apparatus using, instead of the infrared cut filter 4 having small warpage and distortion, a glass substrate 41 that is formed of a material similar to the glass substrate 2 serving as a key component of the imaging apparatus illustrated in FIG. 1 and FIG. 9, and capable of reducing infrared light.

With such a configuration, since it is possible to suppress warpage and distortion without using the expensive infrared cut filter 4 having small warpage and distortion, it is possible to realize a small-sized and thin imaging apparatus having small optical warpage, distortion, and inclination at low cost, and suppress a flare phenomenon due to diffused reflection of light.

Further, by forming the cavity layer 5 on the front surface of the infrared cut filter 4, the displacement between the incident position of the incident light and the incident position of the totally-reflected and turned-back component, which depends on the distance from the central position of the lens 62, can be made substantially constant. Therefore, the processing load of the signal processing unit 21 can be reduced.

Note that the CSP solid-state imaging element 20 in the imaging apparatus illustrated in FIG. 10 has a configuration obtained by excluding the infrared cut filter 4 from the CSP solid-state imaging element 20 illustrated in FIG. 9 and instead of the glass substrate 2 and providing the glass substrate 41 capable of cutting infrared light, and is adhered to the solid-state imaging element 1 by a transparent adhesive 32. The glass substrate 41 capable of cutting infrared light is, for example, a soda-lime glass that absorbs near infrared light.

### 4. Fourth Embodiment

In the configuration of the CSP solid-state imaging element 20, the lens 62 in the lowermost layer may be formed to have two or more lenses.

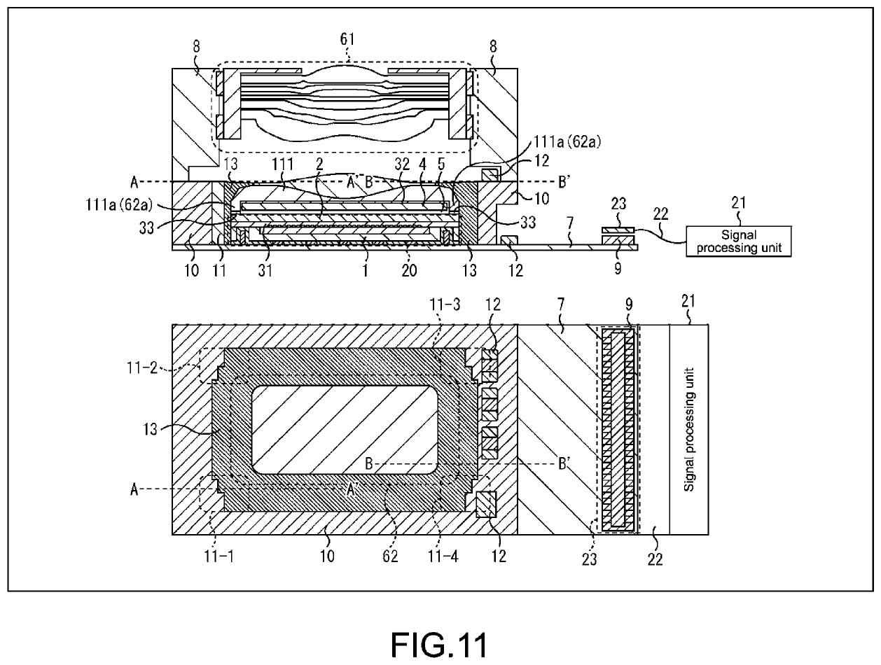

FIG. 11 illustrates a configuration example of the CSP solid-state imaging element 20 in which the lens in the lowermost layer is formed to have two or more lenses. A lens 111 in the lowermost layer in FIG. 11 constitutes a part of the lens 6 that is integrated with the lens 61 in the upper layer, and includes two or more lenses. In FIG. 11, the configuration corresponding to the convex portion 62a in FIG. 1, FIG. 9, and FIG. 10 is a convex portion 111a.

Note that, in the case of using a coating apparatus capable of applying the fixing agent 13 formed of a light absorbing material such as black resin or the mask 81 formed of a black light absorbing material to the mask area Z102 (FIG. 5 and FIG. 6) that is a part of the lens 111 in the lowermost layer with high accuracy at the time of production of an imaging apparatus, there is a possibility that the coating apparatus becomes expensive or a high degree of control is necessary.

In this regard, in the imaging apparatus illustrated in FIG. 11, the mask area Z102 that is the outer peripheral portion of the lens 111 in the lowermost layer is painted black in advance. Accordingly, it is possible to reduce the accuracy of application of the fixing agent 13 formed of black resin or the mask 81 at the time of production of the imaging apparatus. As a result, it is possible to reduce both the apparatus cost and the control cost for the coating apparatus.

Further, by forming the cavity layer 5 on the front surface of the glass substrate 2, the displacement between the incident position of the incident light and the incident position of the totally-reflected and turned-back component, which depends on the distance from the central position of the lens 62, can be made substantially constant. Therefore, the processing load of the signal processing unit 21 can be reduced.

Note that the lens 111 in the lowermost layer may be painted black in advance, or the lens 111 in the lowermost layer may be formed in the CSP solid-state imaging element 20 before the lens 111 in the lowermost layer is painted black. Further, the configuration of the lens 111 in the lowermost layer only needs to include one or more lenses, and may, of course, include a lens group consisting of two or more lenses.

It should be noted that, in the case where the periphery of the center of the lens 111 is lower than the outer peripheral portion thereof, there is a possibility that the applied fixing agent 13 flows toward the center by the action of gravity before being dried, which may narrow the effective pixel area Z101. In this regard, in the case where the periphery of the center of the lens 111 is lower than the outer peripheral portion thereof, it is desirable that the mask 81 is formed by performing mask processing on the mask area Z102.

Further, as illustrated in FIG. 11, in the case where the outer peripheral portion of the lens 62 is lower than the center thereof, any of the fixing agent 13 and the mask 81 can be used because it is unnecessary to take into account the possibility that the fixing agent 13 flows into the center of the lens 62.

### 5. Fifth Embodiment

The example in which the lens 62 in the lowermost layer is formed to have two or more lenses has been described above. However, the mask 81 formed of black resin and the like may be formed in an area of the lens 62, which corresponds to the mask area Z102 in FIG. 6, after the CSP solid-state imaging element 20 and the convex portion 62a of the lens 62 in the lowermost layer are adhered to each other by the adhesive 33 and a portion from the circuit substrate 7 to the upper surface of the glass substrate 2 is fixed by the fixing agent 13.

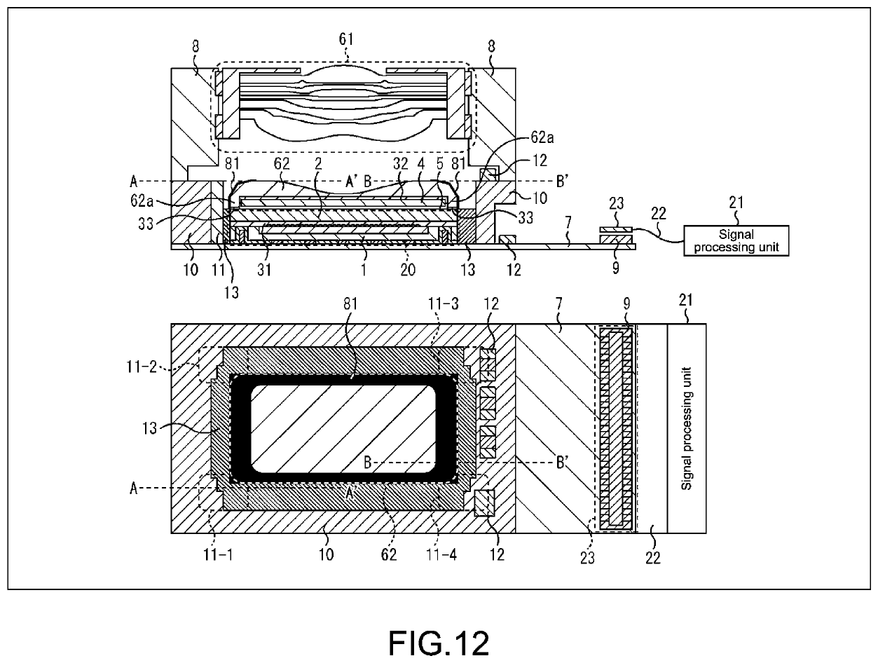

In the imaging apparatus illustrated in FIG. 12, after the glass substrate 2 of the CSP solid-state imaging element 20 and the convex portion 62a of the lens 62 in the lowermost layer are adhered to each other by the adhesive 33 and the portion from the circuit substrate 7 to the upper surface of the glass substrate 2 is fixed by the fixing agent 13, the mask 81 formed of black resin and the like is formed both in the side surface portion of the lens 62 and the area of the lens 62, which corresponds to the mask area Z102 in FIG. 6, from the position of the upper surface of the fixing agent 13 in the figure.

Specifically, in the imaging apparatus illustrated in FIG. 12, the mask area Z102 of the upper surface, which is the outer peripheral portion, is masked by the mask 81 from the side surface portion of the lens 62 in the lowermost layer. Therefore, it is possible to suppress occurrence of ghost and flare.

Further, by forming the cavity layer 5 on the front surface of the glass substrate 2, the displacement between the incident position of the incident light and the incident position of the totally-reflected and turned-back component, which depends on the distance from the central position of the lens 62, can be made substantially constant. Therefore, the processing load of the signal processing unit 21 can be reduced.

### 6. Sixth Embodiment

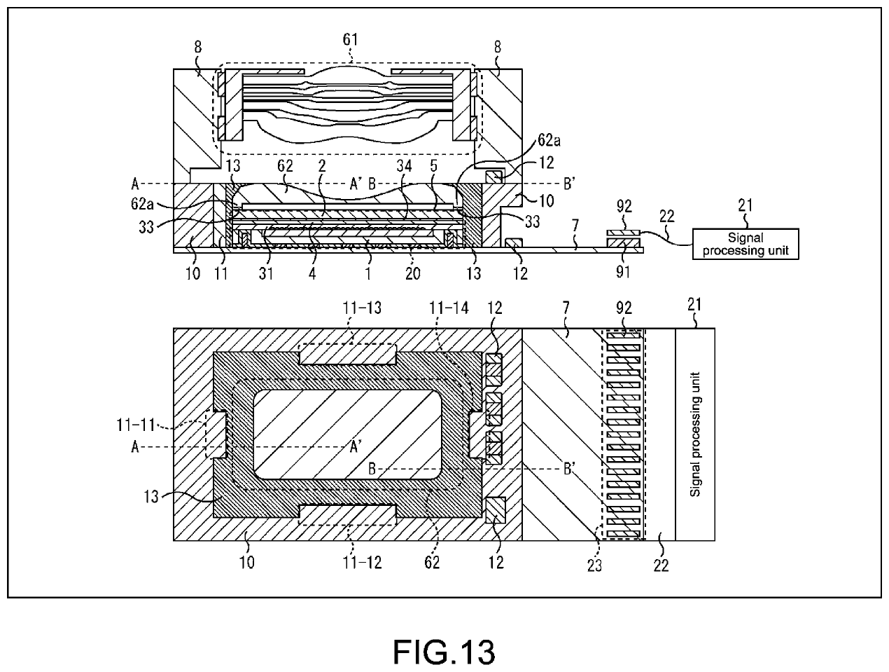

In recent years, it is known that the shape of the circuit substrate 7 of the imaging apparatus is changed for each product due to diversification of camera products on the market. In this regard, as illustrated in FIG. 13, an ACF (Anisotropic Conductive Film) mechanism 91 may be provided on the circuit substrate 7 instead of a connector 9 to realize a small-sized and thin imaging apparatus in which optical warpage, distortion, and inclination are suppressed according to the diversification of camera products without changing the production method for the imaging apparatus. In addition, by providing the cavity layer 5, the processing load of the signal processing unit 21 may be reduced. Note that, in FIG. 13, the cable 22 is connected via a connector 92 corresponding to the ACF mechanism 91 and the image signal is output to the signal processing unit 21.

Further, the configuration example in which the fixing portions 11-1 to 11-4 are provided at positions on the spacer 10 so as to guide the four corners of the CSP solid-state imaging element 20 to appropriate positions has been described above. However, the fixing portions 11-1 to 11-4 may be provided at other positions.

FIG. 13 illustrates a configuration example of the imaging apparatus in which fixing portions 11-11 to 11-14 are provided instead of the fixing portions 11-1 to 11-4.

Specifically, the fixing portions 11-11 to 11-14 are provided on the spacer 10 so as to guide the periphery of the central portions of the four sides of the CSP solid-state imaging element 20 to appropriate positions. Along with this, the fixing agent 13 is injected into the periphery of the four corners of the CSP solid-state imaging element 20, and fixed to the spacer 10.

As described above, by providing the fixing portions 11 so as to guide the four sides of the CSP solid-state imaging element 20 to appropriate positions, it is possible to place the CSP solid-state imaging element 20 at an appropriate position on the circuit substrate 7 with high accuracy.

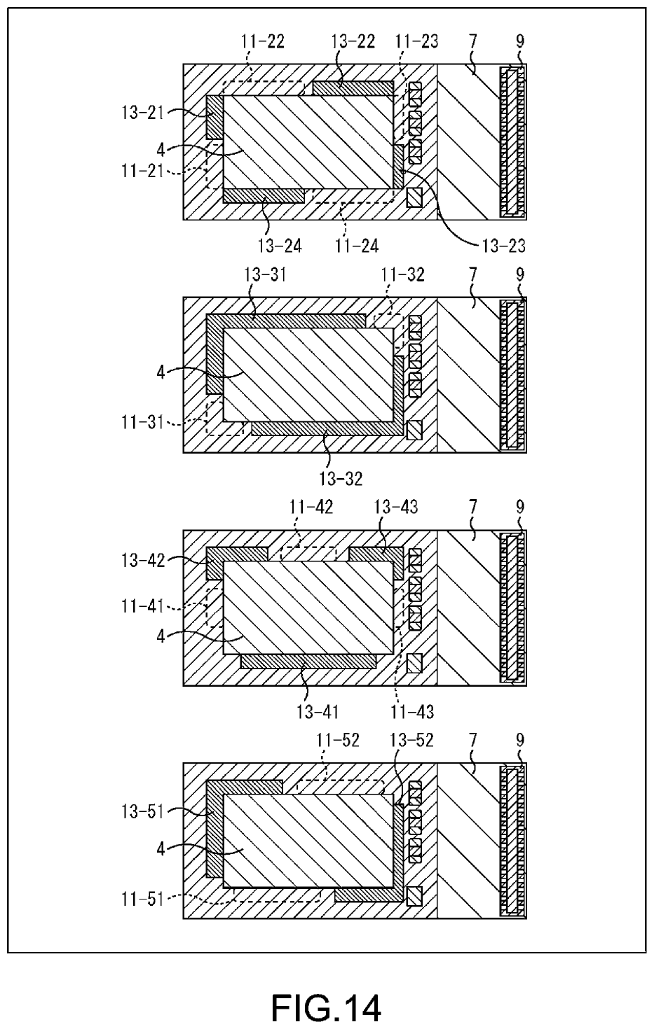

The arrangement of the fixing portions 11 is not limited to the above. For example, as illustrated in the uppermost part of FIG. 14, fixing portions 11-21 to 11-24 may be provided at positions on the spacer 10 corresponding to end portions of the four sides of the CSP solid-state imaging element 20. In this case, the fixing agent 13 is injected into fixing agents 13-21 to 13-24.

Similarly, as illustrated in the second part from the top of FIG. 14, fixing portions 11-31 and 11-32 may be provided at positions on the spacer 10 corresponding to corner portions on any diagonal line of the CSP solid-state imaging element 20. In this case, the fixing agent 13 is injected into fixing agents 13-31 and 13-32. Also in the example of the second part from the top of FIG. 14, the four sides of the CSP solid-state imaging element 20 are fixed by the fixing portions 11-31 and 11-32.

Even in the case where the fixing portions 11 for guiding all of the four sides of the CSP solid-state imaging element 20 to appropriate positions are not used, by guiding a part of the CSP solid-state imaging element 20 to an appropriate position, it is possible to place the CSP solid-state imaging element 20 at an appropriate position with high accuracy as compared with the case where the fixing portions 11 are not provided.

For example, as illustrated in the second part from the bottom of FIG. 14, fixing portions 11-41 to 11-43 may be provided at positions on the spacer 10 so as to guide three sides of the CSP solid-state imaging element 20 to appropriate positions. In this case, the fixing agent 13 is injected into fixing agents 13-41 to 13-43, for example. In this case, only the three sides of the CSP solid-state imaging element 20 are fixed. However, it is possible to place the CSP solid-state imaging element 20 at an appropriate position at least in the direction in which opposite sides are fixed.

Further, for example, as illustrated in the lowermost part of FIG. 14, fixing portions 11-51 and 11-52 may be provided at positions on the spacer 10 corresponding to two opposite sides of the CSP solid-state imaging element 20. In this case, the fixing agent 13 is injected into fixing agents 13-51 and 13-52, for example. In this case, only the two opposite sides of the CSP solid-state imaging element 20 in the vertical direction in FIG. 14 are fixed. However, it is possible to place the CSP solid-state imaging element 20 at an appropriate position at least in the vertical direction in which the opposite sides are fixed.

Specifically, by providing the fixing portions 11 so as to guide at least two opposite sides of the CSP solid-state imaging element 20 having a rectangular shape to appropriate positions, it is possible to improve the accuracy of placing the CSP solid-state imaging element 20.

Note that, although, in the imaging apparatus illustrated in FIG. 13, configuration examples identical to those of the imaging apparatus illustrated in FIG. 9 are used as the configurations of the lens 62, the convex portion 62a, the adhesive 33, the cavity layer 5, the glass substrate 2, an adhesive 34, the infrared cut filter 4, the adhesive 31, and the solid-state imaging element 1, any configurations of FIG. 1 and FIG. 10 to FIG. 12 can be used therefor. Further, although the connector 9 is used in FIG. 14, the ACF mechanism 91 may be used.

As a result, also in the imaging apparatus illustrated in FIG. 13, by forming the cavity layer 5 on the front surface of the glass substrate 2, the displacement between the incident position of the incident light and the incident position of the totally-reflected and turned-back component, which depends on the distance from the central position of the lens 62, can be made substantially constant. Therefore, the processing load of the signal processing unit 21 can be reduced.

### 7. Seventh Embodiment

Hereinabove, in the case where the lens 62, the infrared cut filter 4, the cavity layer 5, the glass substrate 2, and the solid-state imaging element 1 are arranged in the stated order with respect to the incident direction of the incident light, the infrared cut filter 4 is adhered to the lens 62 by the adhesive 32 as illustrated in FIG. 1, FIG. 11, and FIG. 12. However, the infrared cut filter 4 may be adhered to the glass substrate 2 and the cavity layer 5 may be provided between the lens 62 and the infrared cut filter 4.

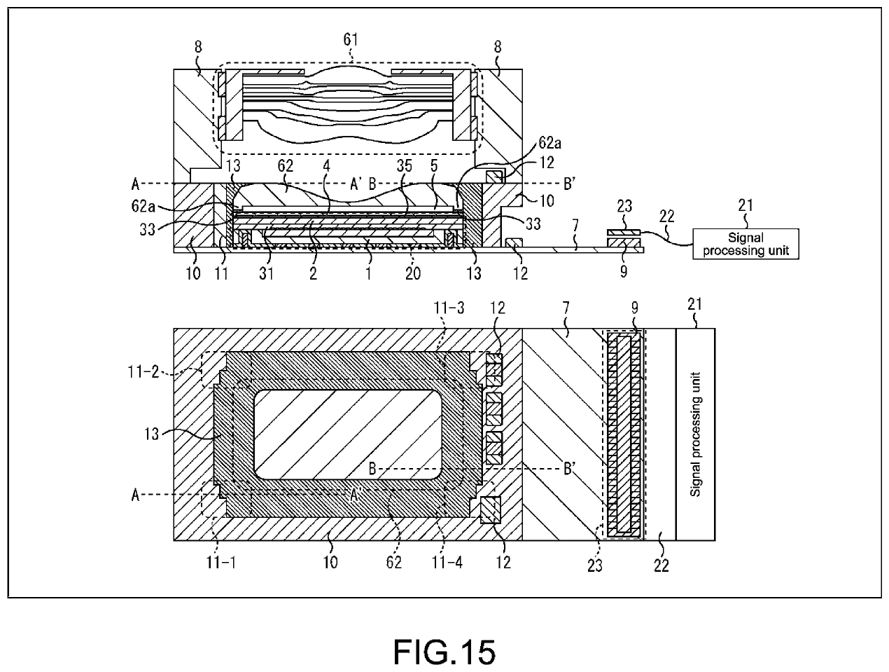

FIG. 15 illustrates a configuration example of the imaging apparatus in which the infrared cut filter 4 is adhered to the glass substrate 2 and the cavity layer 5 is provided between the lens 62 and the infrared cut filter 4.

In the imaging apparatus illustrated in FIG. 15, the convex portion 62a of the lens 62 and the peripheral portion of the upper surface of the infrared cut filter 4 in the figure are adhered to each other by the adhesive 33, and the cavity layer 5 is formed between the lens 62 and the infrared cut filter 4.

In FIG. 15, the lower surface of the infrared cut filter 4 in the figure and the glass substrate 2 are adhered to each other by a transparent adhesive 35.

Further, by forming the cavity layer 5 on the front surface of the infrared cut filter 4 with respect to the incident direction of the incident light, the displacement between the incident position of the incident light and the incident position of the totally-reflected and turned-back component, which depends on the distance from the central position of the lens 62, can be made substantially constant. Therefore, the processing load of the signal processing unit 21 can be reduced. It should be noted that, in FIG. 15, the totally-reflected components and the totally-reflected and turned-back components travel back and forth inside the glass substrate 2 and the infrared cut filter 4 sandwiching the adhesive 34.

### 8. Eighth Embodiment

The example in which the cavity layer 5 is formed between the lens 62 and the infrared cut filter 4 has been described above. However, if it is difficult to provide the convex portion 62a in forming the lens 62, a spacer corresponding to the convex portion 62a may be additionally provided.

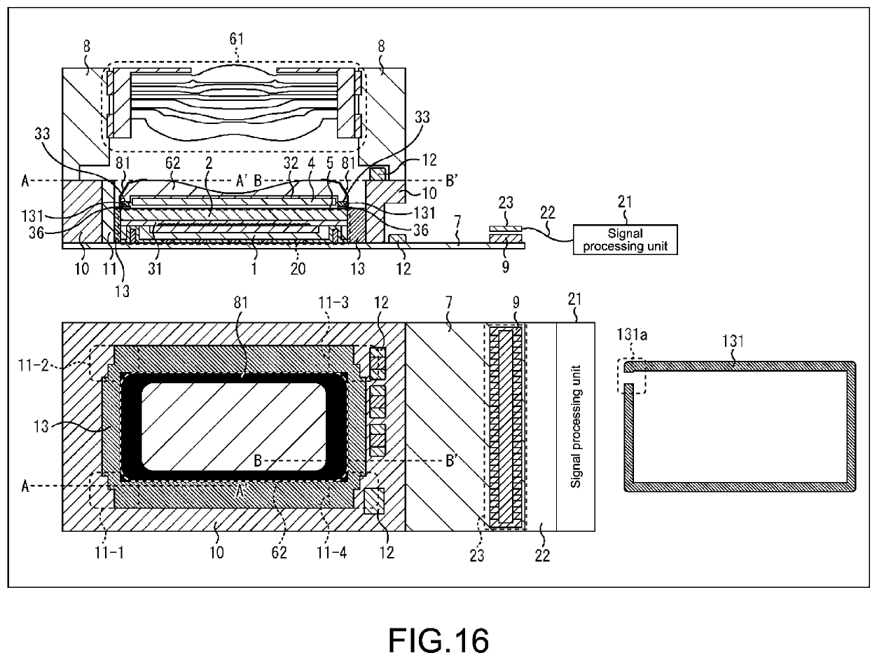

FIG. 16 illustrates a configuration example of the imaging element in which the spacer corresponding to the convex portion 62a is additionally provided such that the cavity layer 5 can be formed without providing the lens 62 with the convex portion 62a.

Specifically, in the imaging apparatus illustrated in FIG. 16, instead of the convex portion 62a of the lens 62 in the imaging apparatus illustrated in FIG. 12, a spacer 131 is provided and the cavity layer 5 is formed due to the spacer 131.

In more detail, the lens 62 is not provided with the convex portion 62a. Therefore, the upper surface of the spacer 131 in the figure is adhered to the peripheral portion of the lower surface of the lens 62 in the figure by the adhesive 33. Further, the lower surface of the spacer 131 in the figure is adhered to the peripheral portion of the glass substrate 2 by an adhesive 36. In addition, as illustrated in the right part of FIG. 16, a part of the peripheral portion of the spacer 131 is not connected, and an air path 131a is formed as a passageway for the air of the air layer. The air path 131a enables the air inside the cavity layer 5 to flow in and out when the air expands and contracts due to changes in the ambient temperature, to thereby suppress occurrence of distortion due to the expansion and contraction of the hermetically sealed air. Note that, although the air path 131a is provided at the upper left position in FIG. 16 as an example, the air path 131a can be provided at any position as long as the air path 131a is provided. Further, the air paths 131a may be provided at a plurality of positions.

### 9. Regarding Configuration of CSP Solid-State Imaging Element

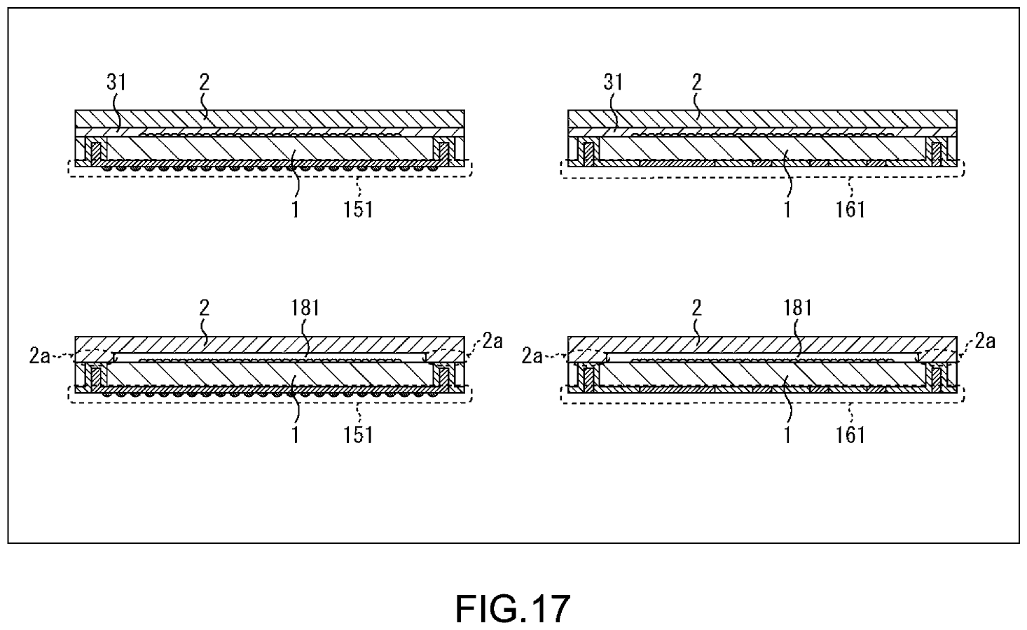

Among the configuration of the CSP solid-state imaging element 20, the connection portion of the circuit substrate 7 may be any of a BGA (Ball Grid Array) terminal 151 illustrated in the upper left part of FIG. 17 and a LGA (Land Grid Array) terminal 161 illustrated in the upper right part of FIG. 17.

Further, for the glass substrate 2 among the configurations of the CSP solid-state imaging element 20, a configuration in which a frame 2a is provided in the periphery thereof and a cavity 181 is provided between the solid-state imaging element 1 and the glass substrate 2 as illustrated in the lower left part and the lower right part of FIG. 17 may be employed.

Even with any of the connection portions, the displacement between the incident position of the incident light to the solid-state imaging element 1 and the incident position of the totally-reflected and turned-back component is substantially constant in the imaging surface of the solid-state imaging element 1, with the above-mentioned configuration. Therefore, the load related to the correction processing of the signal processing unit 21 can be reduced.

### 10. Application Example to Electronic Apparatus

The above-mentioned imaging element may be applied to, for example, various electronic apparatuses including imaging apparatuses such as digital still cameras and digital video cameras, mobile phones having imaging functions, or other apparatuses having imaging functions.

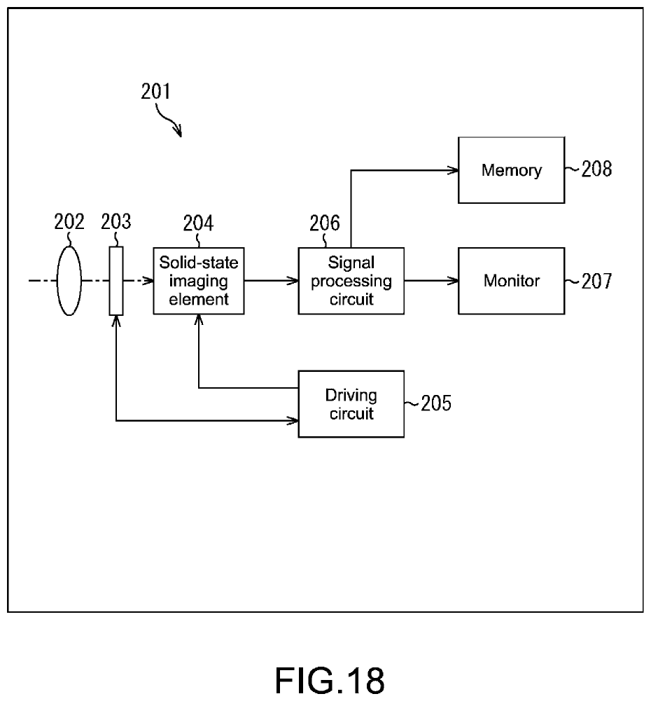

FIG. 18 is a block diagram illustrating a configuration example of an imaging apparatus as an electronic apparatus to which an embodiment of the present technology is applied.

An imaging apparatus 201 illustrated in FIG. 18 includes an optical system 202, a shutter apparatus 203, a solid-state imaging element 204, a driving circuit 205, a signal processing circuit 206, a monitor 207, and a memory 208, and is capable of capturing still images and moving images.

The optical system 202 includes one or a plurality of lenses and guides light (incident light) from an object to the solid-state imaging element 204 to form an image on the image receiving surface of the solid-state imaging element 204.

The shutter apparatus 203 is arranged between the optical system 202 and the solid-state imaging element 204 and controls a light irradiation period and a light shielding period to the solid-state imaging element 204 according to the control of the driving circuit 205.

The solid-state imaging element 204 includes a package including the above-mentioned solid-state imaging element. The solid-state imaging element 204 accumulates signal charges for a certain period of time according to the light guided onto the light-receiving surface via the optical system 202 and the shutter apparatus 203. The signal charges accumulated in the solid-state imaging element 204 are transferred according to a driving signal (timing signal) supplied from the driving circuit 205.

The driving circuit 205 outputs driving signals for controlling the transfer operation of the solid-state imaging element 204 and the shutter operation of the shutter apparatus 203 to drive the solid-state imaging element 204 and the shutter apparatus 203.

The signal processing circuit 206 applies various signal processing to signal charges output from the solid-state imaging element 204. An image (image data) obtained when the signal processing circuit 206 applies the signal processing to the pixel signals is supplied to and displayed on the monitor 207 or is supplied to and stored (recorded) in the memory 208.

Also in the imaging apparatus 201 configured as described above, by applying the CSP solid-state imaging element 20 of the above-mentioned imaging apparatus illustrated in FIG. 1, FIG. 5 to FIG. 13, FIG. 15, and FIG. 16 to the optical system 202 and the solid-state imaging element 204, the displacement between the incident position of the incident light to the solid-state imaging element 1 and the incident position of the totally-reflected and turned-back component can be made substantially constant in the imaging surface of the solid-state imaging element 1. Therefore, the load related to the correction processing of the signal processing unit 21 can be reduced.

### 11. Usage Example of Imaging Element

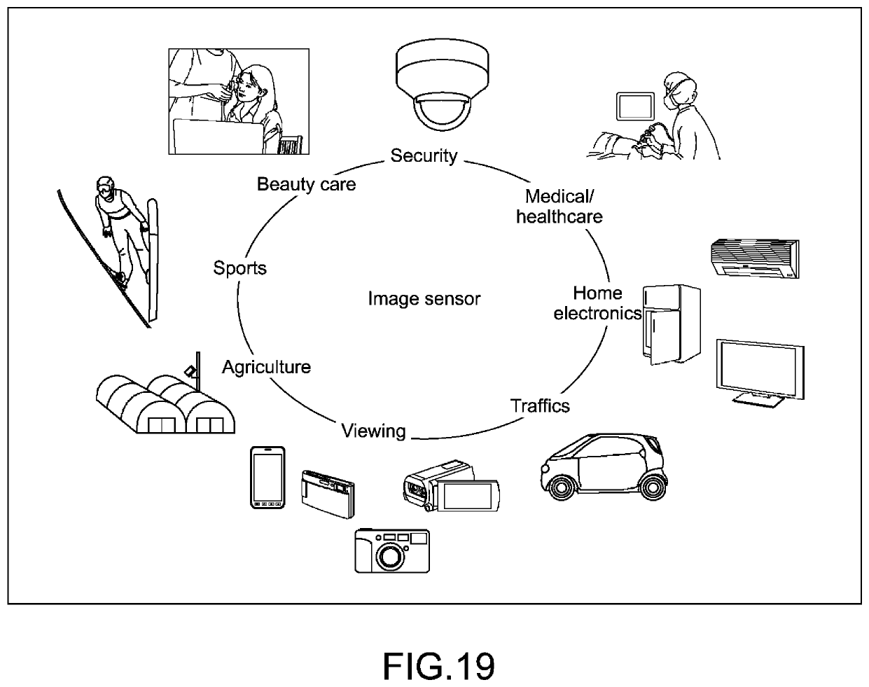

FIG. 19 is a diagram illustrating a usage example of using the above-mentioned imaging apparatus illustrated in FIG. 1, FIG. 5 to FIG. 13, and FIG. 15 to FIG. 16.

The above-mentioned imaging apparatus can be used in various cases of sensing light such as visible light, infrared light, ultraviolet light, and X-rays as follows.
An apparatus for photographing images to be viewed, such as a digital camera and a camera-equipped mobile apparatus
An apparatus used for traffic purposes, such as a car-mounted camera that photographs front/rear/periphery/inside of an automobile, a surveillance camera that monitors running vehicles and roads, and a distance measurement sensor that measures distances among vehicles, for safe driving such as automatic stop, recognition of a driver's state, and the like
An apparatus used in home electronics such as a TV, a refrigerator, and an air conditioner, for photographing gestures of users and executing apparatus operations according to the gestures
An apparatus used for medical and healthcare purposes, such as an endoscope and an apparatus that performs blood vessel photographing by receiving infrared light
An apparatus used for security purposes, such as a surveillance camera for crime-prevention purposes and a camera for person authentication purposes
An apparatus used for beauty care purposes, such as a skin measurement apparatus that photographs skins and a microscope that photographs scalps
An apparatus used for sports purposes, such as an action camera and a wearable camera for sports purposes
An apparatus for agriculture purposes, such as a camera for monitoring a state of fields and crops

### 12. Example of Application to Internal Information Acquisition System

The technology according to the present disclosure (present technology) may be applied to various products. For example, the technology according to the present disclosure may be applied to an endoscopic surgery system.

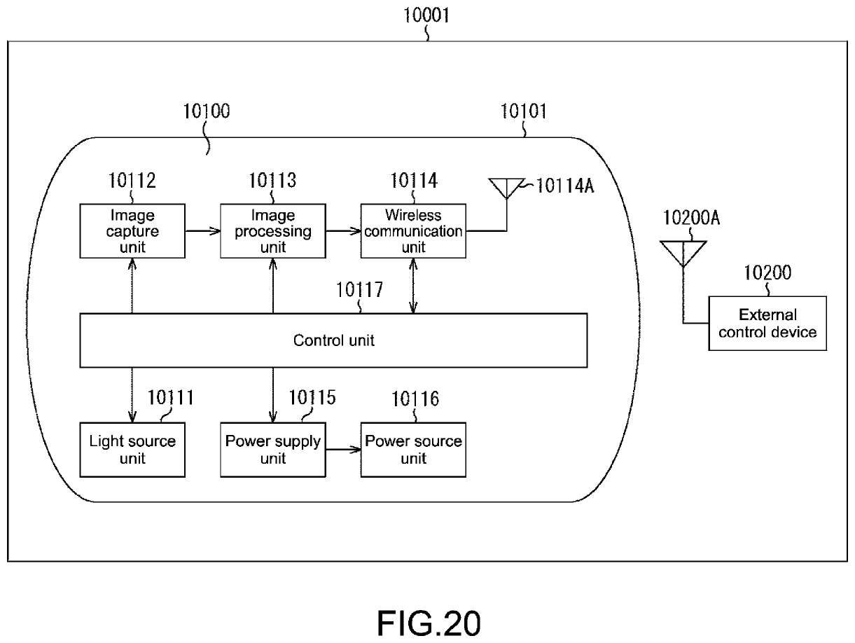

FIG. 20 is a block diagram illustrating an example of a schematic configuration of an internal information acquisition system for a patient, which uses an endoscopic capsule, to which the technology (present technology) according to the present disclosure may be applied.

An internal information acquisition system 10001 includes an endoscopic capsule 10100 and an external control device 10200.

The endoscopic capsule 10100 is swallowed by a patient in an examination. The endoscopic capsule 10100 has an image capture function and a wireless communication function. The endoscopic capsule 10100 moves through the interior of organs such as the stomach and the intestines by peristaltic movement or the like until being excreted naturally from the patient, while also successively capturing images (hereinafter, also referred to as internal images) of the interior of the relevant organs at predetermined intervals, and successively wirelessly transmitting information about the internal images to the external control device 10200 outside the body.

The external control device 10200 centrally controls the operation of the internal information acquisition system 10001. Further, the external control device 10200 receives information about the internal images transmitted from the endoscopic capsule 10100. Based on the received information about the internal images, the external control device 10200 generates image data for displaying the internal images on a display device (not illustrated).

In this way, with the internal information acquisition system 10001, images depicting the patient's internal conditions can be obtained continually from the time the endoscopic capsule 10100 is swallowed to the time the endoscopic capsule 10100 is excreted.

The configurations and functions of the endoscopic capsule 10100 and the external control device 10200 will be described in further detail.

The endoscopic capsule 10100 includes a capsule-shaped housing 10101, and includes a light source unit 10111, an image capture unit 10112, an image processing unit 10113, a wireless communication unit 10114, a power supply unit 10115, a power source unit 10116, and a control unit 10117 built in the capsule-shaped housing 10101.

The light source unit 10111 includes a light source such as a light-emitting diode (LED), for example, and irradiates the imaging field of the image capture unit 10112 with light.

The image capture unit 10112 includes an image sensor, and an optical system made up of multiple lenses provided in front of the image sensor. Reflected light (hereinafter, referred to as observation light) from the light radiated to a body tissue which is an object of observation is condensed by the optical system and incident on the image sensor. The image sensor of the image capture unit 10112 receives and photoelectrically converts the observation light, to thereby generate an image signal corresponding to the observation light. The image signal generated by the image capture unit 10112 is provided to the image processing unit 10113.

The image processing unit 10113 includes a processor such as a central processing unit (CPU) and a graphics processing unit (GPU), and performs various types of signal processing on the image signal generated by the image capture unit 10112. The image processing unit 10113 provides the image signal subjected to the signal processing to the wireless communication unit 10114 as raw data.

The wireless communication unit 10114 performs predetermined processing such as modulation processing on the image signal that was subjected to the signal processing by the image processing unit 10113, and transmits the image signal to the external control device 10200 via an antenna 10114A. In addition, the wireless communication unit 10114 receives, from the external control device 10200 via the antenna 10114A, a control signal related to driving control of the endoscopic capsule 10100. The wireless communication unit 10114 provides control signals received from the external control device 10200 to the control unit 10117.

The power supply unit 10115 includes, for example, an antenna coil for receiving power, a power regeneration circuit for regenerating power from a current produced in the antenna coil, and a voltage step-up circuit. In the power supply unit 10115, the principle of what is called contactless or wireless charging is used for generating power.

The power source unit 10116 includes a secondary battery, and stores power generated by the power supply unit 10115. FIG. 20 omits arrows or the like indicating the recipients of power from the power source unit 10116 for brevity, but power stored in the power source unit 10116 is supplied to the light source unit 10111, the image capture unit 10112, the image processing unit 10113, the wireless communication unit 10114, and the control unit 10117, and may be used for driving these components.

The control unit 10117 includes a processor such as a CPU. The control unit 10117 appropriately controls driving of the light source unit 10111, the image capture unit 10112, the image processing unit 10113, the wireless communication unit 10114, and the power supply unit 10115 in accordance with a control signal transmitted from the external control device 10200.

The external control device 10200 includes a processor such as a CPU and GPU, a microcomputer or a control board on which a processor and a storage element such as a memory are mounted, and the like. The external control device 10200 controls the operation of the endoscopic capsule 10100 by transmitting a control signal to the control unit 10117 of the endoscopic capsule 10100 via an antenna 10200A. In the endoscopic capsule 10100, for example, a light irradiation condition under which the light source unit 10111 irradiates a target of observation with light may be changed by a control signal from the external control device 10200. In addition, an image capture condition (such as the frame rate and the exposure level in the image capture unit 10112) may be changed by a control signal from the external control device 10200. In addition, the content of processing in the image processing unit 10113 and a condition (such as the transmission interval and the number of images to be transmitted) under which the wireless communication unit 10114 transmits the image signal may be changed by a control signal from the external control device 10200.

Moreover, the external control device 10200 performs various types of image processing on the image signal transmitted from the endoscopic capsule 10100, and generates image data for displaying a captured internal image on a display device. For the image processing, various known signal processing, such as a development process (demosaicing process), an image quality-improving process (such as a band enhancement process, a super-resolution process, a noise reduction (NR) process, and/or a shake correction process), and/or an enlargement process (electronic zoom process), may be performed. The external control device 10200 controls driving of a display device (not illustrated), and causes the display device to display a captured internal image on the basis of the generated image data. Alternatively, the external control device 10200 may also cause a recording device (not illustrated) to record the generated image data, or cause a printing device (not illustrated) to make a printout of the generated image data.

The above describes an example of the internal information acquisition system to which the technology according to the present disclosure may be applied. The technology according to the present disclosure may be applied to the image capture unit 10112 of the above-mentioned configurations, for example. Specifically, the CSP solid-state imaging element 20 of the imaging apparatus illustrated in FIG. 1, FIG. 5 to FIG. 13, FIG. 15, and FIG. 16 may be applied to the image capture unit 10112. By applying the technology according to the present disclosure to the image capture unit 10112, the displacement between the incident position of the incident light to the solid-state imaging element 1 and the incident position of the totally-reflected and turned-back component can be made substantially constant in the imaging surface of the solid-state imaging element 1. Therefore, the load related to the correction processing of the signal processing unit 21 can be reduced.

### 13. Example of Application to Endoscopy Surgery System

The technology according to the present disclosure (present technology) may be applied to various products. For example, the technology according to the present disclosure may be applied to an endoscopy surgery system.

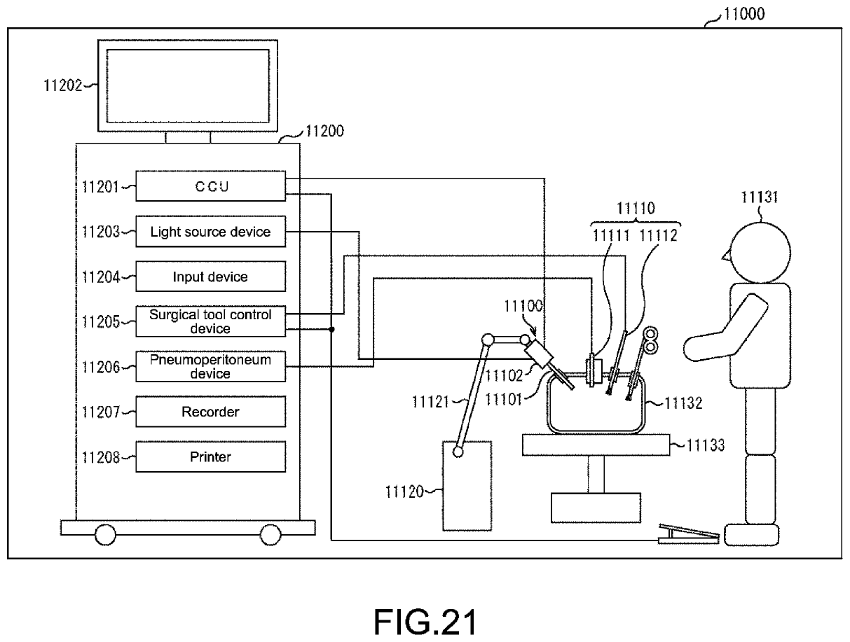

FIG. 21 is a diagram illustrating an example of a schematic configuration of an endoscopy surgery system, to which the technology according to the present disclosure (present technology) may be applied.

FIG. 21 illustrates that a surgeon (doctor) 11131 performs surgery on a patient 11132 on a patient bed 11133 by using an endoscopy surgery system 11000. As illustrated in the figure, the endoscopy surgery system 11000 includes an endoscope 11100, other surgical instruments 11110 such as a pneumoperitoneum tube 11111 and an energy surgical tool 11112, a support arm device 11120 that supports the endoscope 11100, and a cart 11200 including various kinds of built-in endoscopy-surgical devices.

The endoscope 11100 includes a lens tube 11101 and a camera head 11102, part of the lens tube 11101 from the tip having a predetermined length being inserted in the body cavity of the patient 11132, the camera head 11102 being connected to the base of the lens tube 11101. The figure illustrates the endoscope 11100 including the rigid lens tube 11101, i.e., a so-called rigid endoscope, for example. Alternatively, the endoscope 11100 may be a so-called flexible endoscope including a flexible lens tube.

The lens tube 11101 has an opening at the tip, an objective lens being fitted in the opening. A light source device 11203 is connected to the endoscope 11100. The light source device 11203 generates light, a light guide extending in the lens tube 11101 guides the light to the tip of the lens tube, the light passes through the objective lens, and an object of observation in the body cavity of the patient 11132 is irradiated with the light. The endoscope 11100 may be a direct-viewing endoscope, an oblique-viewing endoscope, or a side-viewing endoscope.

The camera head 11102 includes an optical system and an image sensor inside. Reflected light (observation light) from the object of observation is condensed on the image sensor by the optical system. The image sensor photoelectrically converts the observation light to thereby generate an electric signal corresponding to the observation light, i.e., an image signal corresponding to an observation image. The image signal, as raw data, is transmitted to a camera control unit (CCU) 11201.

The CCU 11201 includes a central processing unit (CPU), a graphics processing unit (GPU), or the like, and centrally controls the operation of the endoscope 11100 and a display device 11202. Further, the CCU 11201 receives the image signal from the camera head 11102, and performs various types of image processing, e.g., a development process (demosaicing process) and the like, on the image signal. An image is to be displayed on the basis of the image signal.

Controlled by the CCU 11201, the display device 11202 displays an image on the basis of the image signal subjected to the image processing by the CCU 11201.

The light source device 11203 includes a light source such as a light emitting diode (LED), for example, and supplies light to the endoscope 11100, a surgery site or the like being irradiated with the light when its image is captured.

An input device 11204 is an input interface for the endoscopy surgery system 11000.

A user may input various kinds of information and instructions in the endoscopy surgery system 11000 via the input device 11204. For example, a user inputs instructions to change image capture conditions (kind of irradiation light, magnifying power, focal length, and the like) of the endoscope 11100, and other instructions.

A surgical tool control device 11205 controls the driving of the energy surgical tool 11112 that cauterizes a tissue, incises a tissue, seals a blood vessel, or the like. A pneumoperitoneum device 11206 feeds gas into the body cavity via the pneumoperitoneum tube 11111 in order to swell up the body cavity of the patient 11132 for the purpose of securing the imaging field of the endoscope 11100 and securing the workspace for a surgeon. A recorder 11207 is a device capable of recording various kinds of surgical information. A printer 11208 is a device capable of printing the various kinds of surgical information in various kinds of formats such as a text, an image, and a graph.

The light source device 11203, which supplies irradiation light to the endoscope 11100 when an image of a surgery site is captured, may include an LED, a laser light source, or a white light source including a combination of them, for example. Where the white light source includes a combination of RGB laser light sources, the light source device 11203 may adjust the white balance of a captured image since the output intensity and the output timing of each color (each wavelength) may be controlled with a high degree of accuracy. Further, in this case, by irradiating an object of observation with laser lights from the respective RGB laser light sources in time-division and by controlling the driving of the image sensor of the camera head 11102 in synchronization with the irradiation timings, images respectively corresponding to RGB may be captured in time-division. In accordance with this method, the image sensor without color filters may obtain color images.

Further, the driving of the light source device 11203 may be controlled to change the intensity of output light at predetermined time intervals. By controlling the driving of the image sensor of the camera head 11102 in synchronization with the timings of changing the intensity of the light to thereby obtain images in time-division and by combining the images, high-dynamic-range images without so-called black-clipping and white-clipping may be generated.

Further, the light source device 11203 may be configured to be capable of supplying light having a predetermined wavelength band corresponding to special light imaging. An example of the special light imaging is so-called narrow band imaging, which makes use of the fact that absorption of light by a body tissue depends on the wavelength of light. In the narrow band imaging, a body tissue is irradiated with light having a narrower band than the band of irradiation light (i.e., white light) in the normal imaging, and thereby a high-contrast image of a predetermined tissue such as a blood vessel of a mucous membrane surface is captured. Another possible example of the special light imaging is fluorescence imaging, in which a body tissue is irradiated with excitation light, fluorescence is thereby generated, and a fluorescence image is obtained. In the fluorescence imaging, a body tissue is irradiated with excitation light, and fluorescence from the body tissue is imaged (auto-fluorescence imaging). For another possible example, a reagent such as indocyanine green (ICG) is locally injected into a body tissue and, in addition, the body tissue is irradiated with excitation light corresponding to the fluorescence wavelength of the reagent to thereby obtain a fluorescence image. The light source device 11203 may be configured to be capable of supplying narrow band light and/or excitation light corresponding to the special light imaging.

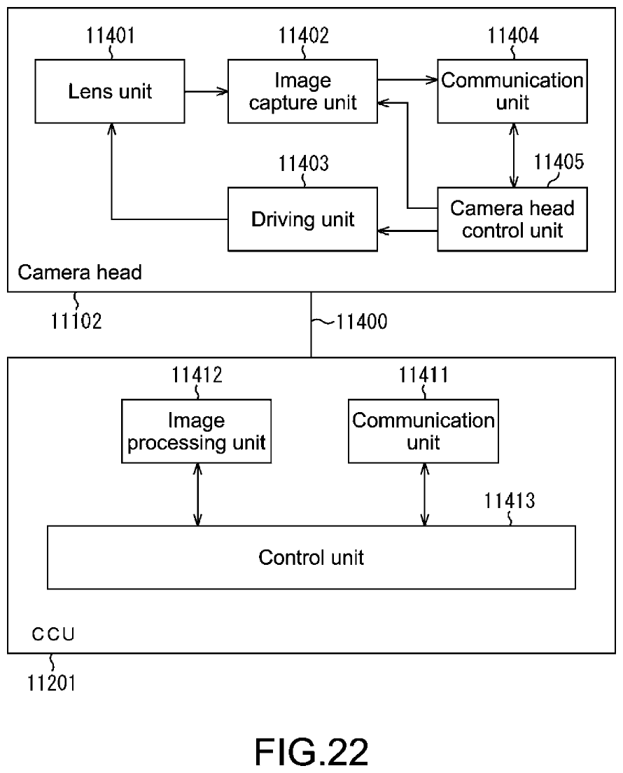

FIG. 22 is a block diagram illustrating an example of a functional configuration of the camera head 11102 and the CCU 11201 of FIG. 21.

The camera head 11102 includes a lens unit 11401, an image capture unit 11402, a driving unit 11403, a communication unit 11404, and a camera head control unit 11405. The CCU 11201 includes a communication unit 11411, an image processing unit 11412, and a control unit 11413. The camera head 11102 is connected to the CCU 11201 via a transmission cable 11400, which enables bidirectional communication.

The lens unit 11401 is an optical system provided at a portion of the camera head 11102, to which the lens tube 11101 is connected. Observation light is introduced from the tip of the lens tube 1110, is guided to the camera head 11102, and enters the lens unit 11401. The lens unit 11401 includes a plurality of lenses including a zoom lens and a focal lens in combination.

The image capture unit 11402 includes an image sensor/image sensors. The image capture unit 11402 may include one (i.e., single) image sensor or a plurality of (i.e., multiple) image sensors. Where the image capture unit 11402 includes multiple image sensors, for example, the respective image sensors may generate image signals corresponding to RGB, and a color image may be obtained by combining the RGB image signals. Alternatively, the image capture unit 11402 may include a pair of image sensors for obtaining right-eye and left-eye image signals corresponding to 3D (Dimensional) display. Thanks to the 3D display, the surgeon 11131 is capable of grasping the depth of a biological tissue at a surgery site more accurately. Where the image capture unit 11402 includes multiple image sensors, a plurality of series of lens units 11401 may be provided corresponding to the image sensors, respectively.

Further, the image capture unit 11402 is not necessarily provided in the camera head 11102. For example, the image capture unit 11402 may be provided immediately after the objective lens in the lens tube 11101.

The driving unit 11403 includes an actuator. Controlled by the camera head control unit 11405, the driving unit 11403 causes the zoom lens and the focal lens of the lens unit 11401 to move for a predetermined distance along the optical axis. As a result, the magnifying power and the focus of an image captured by the image capture unit 11402 may be adjusted appropriately.

The communication unit 11404 includes a communication device for transmitting/receiving various kinds of information to/from the CCU 11201. The communication unit 11404 transmits the image signal obtained from the image capture unit 11402 to the CCU 11201 via the transmission cable 11400 as raw data.

Further, the communication unit 11404 receives a control signal related to driving control of the camera head 11102 from the CCU 11201, and supplies the control signal to the camera head control unit 11405. For example, the control signal includes information about image capture conditions, which includes information for specifying the frame rate of a captured image, information for specifying the exposure level when capturing an image, information for specifying the magnifying power and the focus of a captured image, and/or the like.

The above-mentioned image capture conditions such as the frame rate, the exposure level, the magnifying power, and the focus may be specified appropriately by a user, or may be set automatically on the basis of the obtained image signal by the control unit 11413 of the CCU 11201. In the latter case, it is expected that the endoscope 11100 has the so-called AE (Auto Exposure) function, AF (Auto Focus) function, and AWB (Auto White Balance) function.

The camera head control unit 11405 controls the driving of the camera head 11102 on the basis of the control signal received from the CCU 11201 via the communication unit 11404.

The communication unit 11411 includes a communication device for transmitting/receiving various kinds of information to/from the camera head 11102. The communication unit 11411 receives the image signal transmitted from the camera head 11102 via the transmission cable 11400.

Further, the communication unit 11411 transmits the control signal related to driving control of the camera head 11102 to the camera head 11102. The image signal and the control signal may be transmitted via the electric communication, the optical communication, or the like.

The image processing unit 11412 performs various types of image processing on the image signal transmitted from the camera head 11102 as raw data.

The control unit 11413 performs various types of control on capturing an image of a surgery site or the like by the endoscope 11100 and control on displaying the captured image obtained by capturing the surgery site or the like. For example, the control unit 11413 generates a control signal related to driving control of the camera head 11102.

Further, the control unit 11413 causes the display device 11202 to display a captured image of the surgery site or the like on the basis of the image signal subjected to the image processing by the image processing unit 11412. At this time, the control unit 11413 may recognize various kinds of objects in the captured image by making use of various kinds of image recognition techniques. For example, by detecting the edge shape, the color, and the like of an object in the captured image, the control unit 11413 is capable of recognizing a surgical instrument such as forceps, a certain biological site, bleeding, mist generated when using the energy surgical tool 11112, and the like. When the control unit 11413 causes the display device 11202 to display a captured image, the control unit 11413 may display various kinds of surgery assistance information superimposed on the image of the surgery site by making use of the result of the recognition. By displaying the surgery assistance information superimposed on the image, which is presented to the surgeon 11131, it is possible to reduce the burden on the surgeon 11131 and it is possible for the surgeon 11131 to reliably carry on the surgery.

The transmission cable 11400, which connects the camera head 11102 and the CCU 11201, is an electric signal cable that supports electric signal communication, an optical fiber that supports optical communication, or a composite cable of them.

Here, in the illustrated example, wired communication is performed via the transmission cable 11400. Alternatively, communication between the camera head 11102 and the CCU 11201 may be performed wirelessly.

The above describes an example of the endoscopy surgery system to which the technology according to the present disclosure may be applied. The technology according to the present disclosure may be applied to the endoscope 11100 and the image capture unit 11402 of the camera head 11102 of the above-mentioned configurations, for example. Specifically, the CSP solid-state imaging element 20 of the imaging apparatus illustrated in FIG. 1, FIG. 5 to FIG. 13, FIG. 15, and FIG. 16 may be applied to the image capture unit 11402. By applying the technology according to the present disclosure to the image capture unit 11402, the displacement between the incident position of the incident light to the solid-state imaging element 1 and the incident position of the totally-reflected and turned-back component can be made substantially constant in the imaging surface of the solid-state imaging element 1. Therefore, the load related to the correction processing of the signal processing unit 21 can be reduced.

Although the above describes the endoscopy surgery system for an example, the technology according to the present disclosure may be applied to another system, e.g., a microscope surgery system or the like.

### 14. Example of Application to Movable Object

The technology (present technology) according to the present disclosure can be applied to various products. For example, the technology according to the present disclosure may be realized as a device mounted on any kind of movable objects such as a car, an electric car, a hybrid electric car, a motorcycle, a bicycle, a personal mobility, an aircraft, a drone, a ship, and a robot.

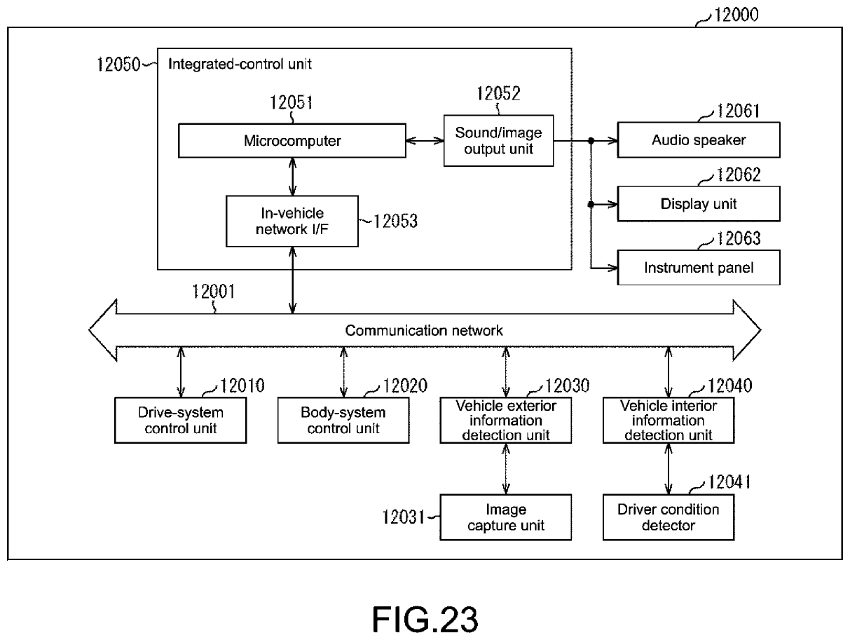

FIG. 23 is a block diagram illustrating an example of a schematic configuration of a vehicle control system, which is an example of a movable object control system to which the technology according to the present disclosure is applied.

A vehicle control system 12000 includes a plurality of electronic control units connected to each other via a communication network 12001. In the example of FIG. 23, the vehicle control system 12000 includes a drive-system control unit 12010, a body-system control unit 12020, a vehicle exterior information detection unit 12030, a vehicle interior information detection unit 12040, and an integrated-control unit 12050. Further, as the functional configuration of the integrated-control unit 12050, a microcomputer 12051, a sound/image output unit 12052, and an in-vehicle network interface (I/F) 12053 are illustrated.

The drive-system control unit 12010 executes various kinds of programs, to thereby control the operations of the devices related to the drive system of the vehicle. For example, the drive-system control unit 12010 functions as a control device that controls driving force generation devices such as an internal-combustion engine and a driving motor for generating a driving force of the vehicle, a driving force transmission mechanism for transmitting the driving force to wheels, a steering mechanism that adjusts the steering angle of the vehicle, a brake device that generates a braking force of the vehicle, and the like.

The body-system control unit 12020 executes various kinds of programs, to thereby control the operations of the various kinds devices equipped in a vehicle body. For example, the body-system control unit 12020 functions as a control device that controls a keyless entry system, a smart key system, a power window device, or various lamps such as head lamps, back lamps, brake lamps, side-turn lamps, and fog lamps. In this case, an electric wave transmitted from a mobile device in place of a key or signals from various switches may be input in the body-system control unit 12020. The body-system control unit 12020 receives the input electric wave or signal, and controls a door lock device, the power window device, the lamps, and the like of the vehicle.

The vehicle exterior information detection unit 12030 detects information outside the vehicle including the vehicle control system 12000. For example, an image capture unit 12031 is connected to the vehicle exterior information detection unit 12030. The vehicle exterior information detection unit 12030 causes the image capture unit 12031 to capture an environment image and receives the captured image. The vehicle exterior information detection unit 12030 may perform an object detection process of detecting a man, a vehicle, an obstacle, a sign, a signage on a road, or the like on the basis of the received image, or may perform a distance detection process on the basis of the received image.

The image capture unit 12031 is an optical sensor that receives light and outputs an electric signal corresponding to the amount of light received. The image capture unit 12031 may output the electric signal as an image or may output as distance measurement information. Further, the light that the image capture unit 12031 receives may be visible light or invisible light such as infrared light.

The vehicle interior information detection unit 12040 detects vehicle interior information. For example, a driver condition detector 12041 that detects the condition of a driver is connected to the vehicle interior information detection unit 12040. For example, the driver condition detector 12041 may include a camera that captures an image of a driver. The vehicle interior information detection unit 12040 may calculate the fatigue level or the concentration level of the driver on the basis of the detected information input from the driver condition detector 12041, and may determine whether the driver is sleeping.

The microcomputer 12051 may calculate the control target value of the driving force generation device, the steering mechanism, or the brake device on the basis of the vehicle interior/vehicle exterior information obtained by the vehicle exterior information detection unit 12030 or the vehicle interior information detection unit 12040, and may output a control command to the drive-system control unit 12010. For example, the microcomputer 12051 may perform coordinated control for the purpose of realizing the advanced driver assistance system (ADAS) function including avoiding a vehicle collision, lowering impacts of a vehicle collision, follow-up driving based on a distance between vehicles, constant speed driving, vehicle collision warning, a vehicle's lane departure warning, or the like.

Further, by controlling the driving force generation device, the steering mechanism, the brake device, or the like on the basis of information about the environment around the vehicle obtained by the vehicle exterior information detection unit 12030 or the vehicle interior information detection unit 12040, the microcomputer 12051 may perform coordinated control for the purpose of realizing self-driving, i.e., autonomous driving without the need of drivers' operations, and the like.

Further, the microcomputer 12051 may output a control command to the body-system control unit 12020 on the basis of vehicle exterior information obtained by the vehicle exterior information detection unit 12030. For example, the microcomputer 12051 may perform coordinated control including controlling the head lamps on the basis of the location of a leading vehicle or an oncoming vehicle detected by the vehicle exterior information detection unit 12030 and changing high beams to low beams, for example, for the purpose of anti-glare.

The sound/image output unit 12052 transmits at least one of a sound output signal and an image output signal to an output device, which is capable of notifying a passenger of the vehicle or a person outside the vehicle of information visually or auditorily. In the example of FIG. 23, an audio speaker 12061, a display unit 12062, and an instrument panel 12063 are illustrated as examples of the output devices. For example, the display unit 12062 may include at least one of an on-board display and a head-up display.

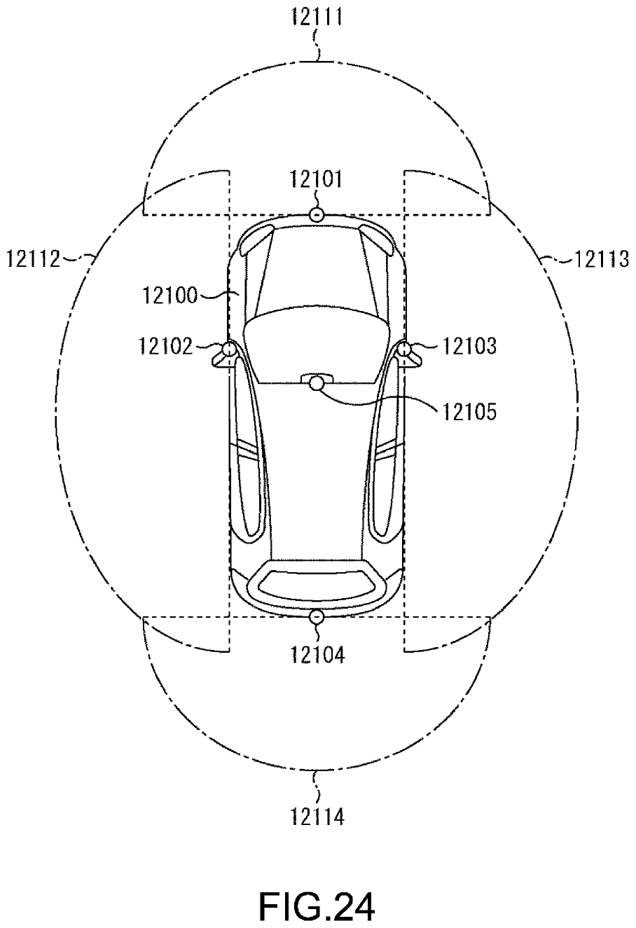

FIG. 24 is a diagram illustrating examples of mounting positions of the image capture units 12031.

In FIG. 24, a vehicle 12100 includes, as the image capture units 12031, image capture units 12101, 12102, 12103, 12104, and 12105.

For example, the image capture units 12101, 12102, 12103, 12104, and 12105 are provided at positions such as the front nose, the side-view mirrors, the rear bumper or the rear door, and an upper part of the windshield in the cabin of the vehicle 12100. Each of the image capture unit 12101 on the front nose and the image capture unit 12105 on the upper part of the windshield in the cabin mainly obtains an image of the front of the vehicle 12100. Each of the image capture units 12102 and 12103 on the side-view minors mainly obtains an image of a side of the vehicle 12100. The image capture unit 12104 on the rear bumper or the rear door mainly obtains an image of the rear of the vehicle 12100. The images of the front obtained by the image capture units 12101 and 12105 are mainly used for detecting a leading vehicle or detecting a pedestrian, an obstacle, a traffic light, a traffic sign, a lane, or the like.

FIG. 24 illustrates examples of image capture ranges of the image capture units 12101 to 12104. The image capture range 12111 indicates the image capture range of the image capture unit 12101 on the front nose, the image capture ranges 12112 and 12113 indicate the image capture ranges of the image capture units 12102 and 12103 on the side-view minors, respectively, and the image capture range 12114 indicates the image capture range of the image capture unit 12104 on the rear bumper or the rear door. For example, by overlaying the image data captured by the image capture units 12101 to 12104 each other, a plane image of the vehicle 12100 as viewed from above is obtained.

At least one of the image capture units 12101 to 12104 may have a function of obtaining distance information. For example, at least one of the image capture units 12101 to 12104 may be a stereo camera including a plurality of image sensors or an image sensor including pixels for phase difference detection.

For example, by obtaining the distance between the vehicle 12100 and each three-dimensional (3D) object in the image capture ranges 12111 to 12114 and the temporal change (relative speed to the vehicle 12100) of the distance on the basis of the distance information obtained from the image capture units 12101 to 12104, the microcomputer 12051 may extract, as a leading vehicle, a 3D object which is especially the closest 3D object driving on the track on which the vehicle 12100 is driving at a predetermined speed (e.g., 0 km/h or more) in the direction substantially the same as the driving direction of the vehicle 12100. Further, by presetting a distance between the vehicle 12100 and a leading vehicle to be secured, the microcomputer 12051 may perform autobrake control (including follow-up stop control), automatic acceleration control (including follow-up start-driving control), and the like. In this way, it is possible to perform coordinated control for the purpose of realizing self-driving, i.e., autonomous driving without the need of drivers' operations, and the like.

For example, the microcomputer 12051 may sort 3D object data of 3D objects into motorcycles, standard-size vehicles, large-size vehicles, pedestrians, and the other 3D objects such as utility poles on the basis of the distance information obtained from the image capture units 12101 to 12104, extract data, and use the data to automatically avoid obstacles. For example, the microcomputer 12051 sorts obstacles around the vehicle 12100 into obstacles that a driver of the vehicle 12100 can see and obstacles that it is difficult for the driver to see. Then, the microcomputer 12051 determines a collision risk, which indicates a hazard level of a collision with each obstacle. When the collision risk is a preset value or more and when there is a possibility of a collision occurrence, the microcomputer 12051 may perform driving assistance to avoid a collision, in which the microcomputer 12051 outputs warning to the driver via the audio speaker 12061 or the display unit 12062, or mandatorily reduces the speed or performs collision-avoidance steering via the drive-system control unit 12010.

At least one of the image capture units 12101 to 12104 may be an infrared camera that detects infrared light. For example, the microcomputer 12051 may recognize a pedestrian by determining whether or not images captured by the image capture units 12101 to 12104 include the pedestrian. The method of recognizing a pedestrian includes, for example, the step of extracting characteristic points in the images captured by the image capture units 12101 to 12104 being infrared cameras, and the step of performing the pattern matching process with respect to a series of characteristic points indicating an outline of an object, to thereby determine whether or not the object is a pedestrian. Where the microcomputer 12051 determines that the images captured by the image capture units 12101 to 12104 include a pedestrian and recognizes the pedestrian, the sound/image output unit 12052 controls the display unit 12062 to display a rectangular contour superimposed on the recognized pedestrian to emphasize the pedestrian. Further, the sound/image output unit 12052 may control the display unit 12062 to display an icon or the like indicating a pedestrian at a desired position.

The above describes an example of the vehicle control system to which the technology according to the present disclosure may be applied. The technology according to the present disclosure may be applied to the image capture unit 12031 of the above-mentioned configurations, for example. Specifically, the CSP solid-state imaging element 20 of the imaging apparatus illustrated in FIG. 1, FIG. 5 to FIG. 13, FIG. 15, and FIG. 16 may be applied to the image capture unit 12031. By applying the technology according to the present disclosure to the image capture unit 12031, the displacement between the incident position of the incident light to the solid-state imaging element 1 and the incident position of the totally-reflected and turned-back component can be made substantially constant in the imaging surface of the solid-state imaging element 1. Therefore, the load related to the correction processing of the signal processing unit 21 can be reduced.

### 15. Configuration Example of Stacked-Type Solid-State Imaging Apparatus to Which Technology According to Present Disclosure Can Be Applied

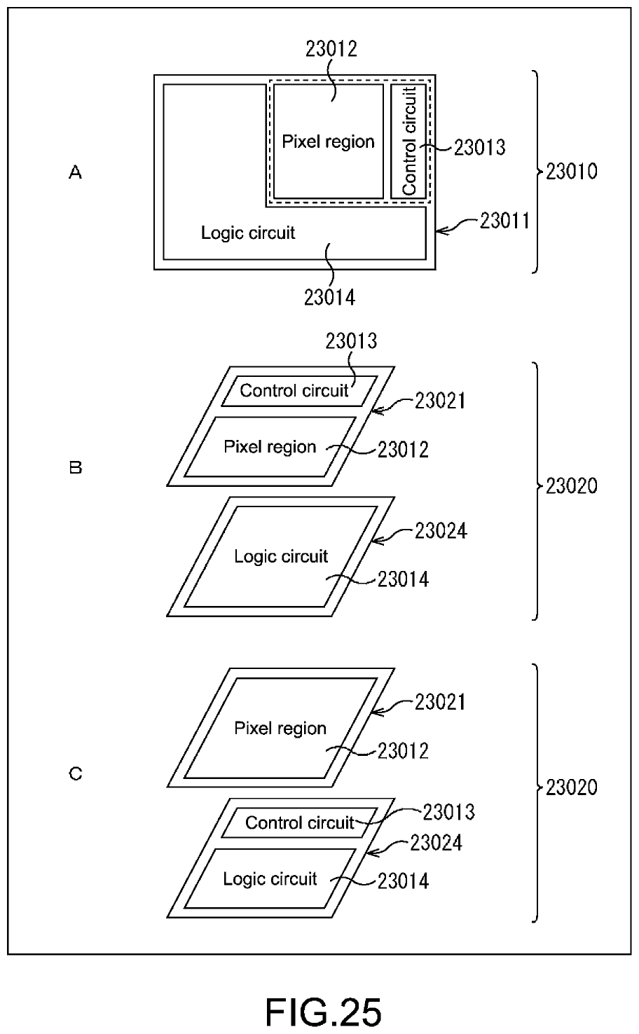

FIG. 25 is a diagram showing the outline of a configuration example of the stacked-type solid-state imaging apparatus to which the technology according to the present disclosure can be applied.

A of FIG. 25 shows a schematic configuration example of a non-stacked-type solid-state imaging apparatus. As shown in A of FIG. 25, a solid-state imaging apparatus 23010 includes a single die (semiconductor substrate) 23011. This die 23011 installs a pixel region 23012 in which pixels are arranged in an array, a control circuit 23013 that controls driving of the pixels and performs other various controls, and a logic circuit 23014 for signal processing.

B and C of FIG. 25 show a schematic configuration example of the stacked-type solid-state imaging apparatus. As shown in B and C of FIG. 25, two dies of a sensor die 23021 and a logic die 23024 are stacked and electrically connected to each other. In this manner, the solid-state imaging apparatus 23020 is configured as a single semi-conductor chip.

In B of FIG. 25, the sensor die 23021 installs the pixel region 23012 and the control circuit 23013. The logic die 23024 installs the logic circuit 23014 including a signal processing circuit that performs signal processing.

In C of FIG. 25, the sensor die 23021 installs the pixel region 23012. The logic die 23024 installs the control circuit 23013 and the logic circuit 23014.

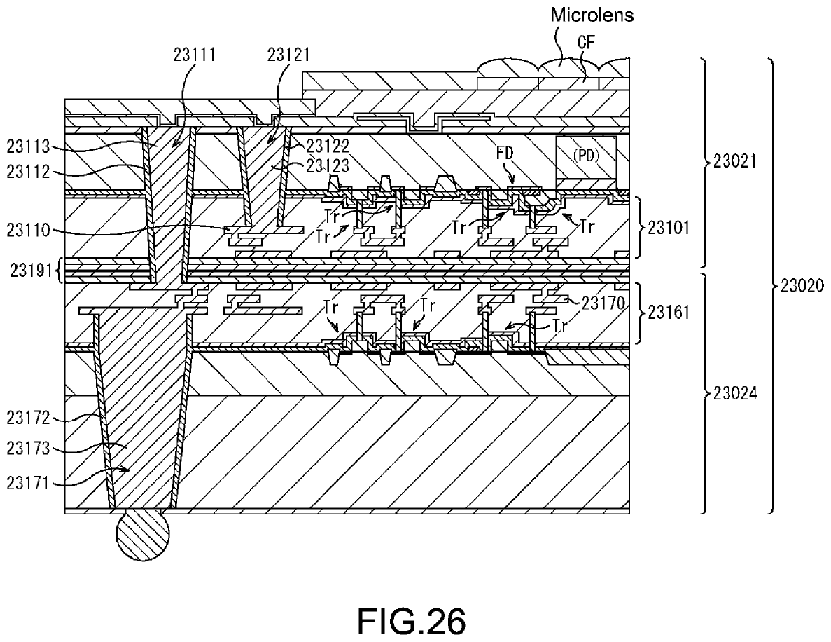

FIG. 26 is a cross-sectional view showing a first configuration example of the stacked-type solid-state imaging apparatus 23020.

In the sensor die 23021, a photodiode (PD), a floating diffusion (FD), and transistors (Tr) (MOS FET), which constitute a pixel that becomes the pixel region 23012, and Tr and the like, which become the control circuit 23013, are formed. In addition, a wiring layer 23101 is formed in the sensor die 23021. The wiring layer 23101 includes a plurality of layers, in this example, three-layer wires 23110. Note that (Tr that becomes) the control circuit 23013 can be formed in not the sensor die 23021 but the logic die 23024.

Tr constituting the logic circuit 23014 is formed in the logic die 23024. In addition, a wiring layer 23161 is formed in the logic die 23024. The wiring layer 23161 includes a plurality of layers, in this example, three-layer wires 23170. Further, a connection hole 23171 is formed in the logic die 23024. The connection hole 23171 has an insulation film 23172 formed on an inner wall surface thereof. A connection conductor 23173 to be connected to the wire 23170 and the like is embedded in the connection hole 23171.

The sensor die 23021 and the logic die 23024 are bonded to each other such that the wiring layers 23101 and 23161 thereof face each other. With this, the stacked-type solid-state imaging apparatus 23020 in which the sensor die 23021 and the logic die 23024 are stacked is formed. A film 23191 such as a protection film is formed in a face on which the sensor die 23021 and the logic die 23024 are bonded to each other.

A connection hole 23111 is formed in the sensor die 23021. The connection hole 23111 penetrates the sensor die 23021 from the backside (side on which light enters the PD) (upper side) of the sensor die 23021 and reaches an uppermost layer wire 23170 of the logic die 23024. In addition, a connection hole 23121 is formed in the sensor die 23021. The connection hole 23121 is located in proximity of the connection hole 23111 and reaches a first-layer wire 23110 from the backside of the sensor die 23021. An insulation film 23112 is formed on an inner wall surface of the connection hole 23111. An insulation film 23122 is formed on an inner wall surface of the connection hole 23121. Then, connection conductors 23113 and 23123 are embedded in the connection holes 23111 and 23121, respectively. The connection conductor 23113 and the connection conductor 23123 electrically connected to each other on the back side of the sensor die 23021. With this, the sensor die 23021 and the logic die 23024 are electrically connected to each other via the wiring layer 23101, the connection hole 23121, the connection hole 23111, and the wiring layer 23161.

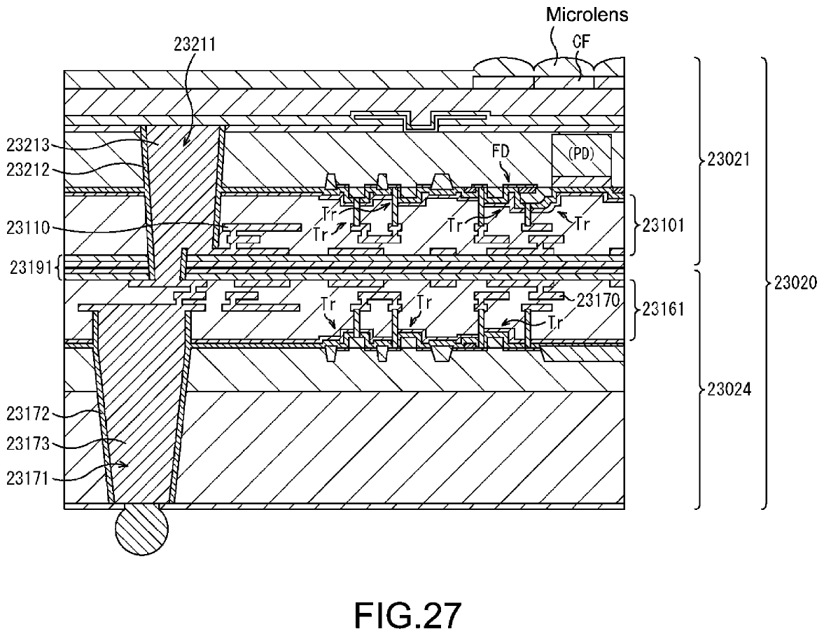

FIG. 27 is a cross-sectional view showing a second configuration example of the stacked-type solid-state imaging apparatus 23020.

In a second configuration example of the solid-state imaging apparatus 23020, ((the wire 23110 of) the wiring layer 23101 of) the sensor die 23021 and ((the wire 23170 of) the wiring layer 23161 of) the logic die 23024 are electrically connected to each other through a single connection hole 23211 formed in the sensor die 23021.

Specifically, in FIG. 27, the connection hole 23211 is formed penetrating the sensor die 23021 from the back side of the sensor die 23021 and reaching an uppermost layer wire 23170 of the logic die 23024 and an uppermost layer wire 23110 of the sensor die 23021. An insulation film 23212 is formed on the inner wall surface of the connection hole 23211. A connection conductor 23213 is embedded in the connection hole 23211. In FIG. 26 described above, the sensor die 23021 and the logic die 23024 are electrically connected to each other through the two connection holes 23111 and 23121. On the other hand, in FIG. 27, the sensor die 23021 and the logic die 23024 are electrically connected to each other through the single connection hole 23211.

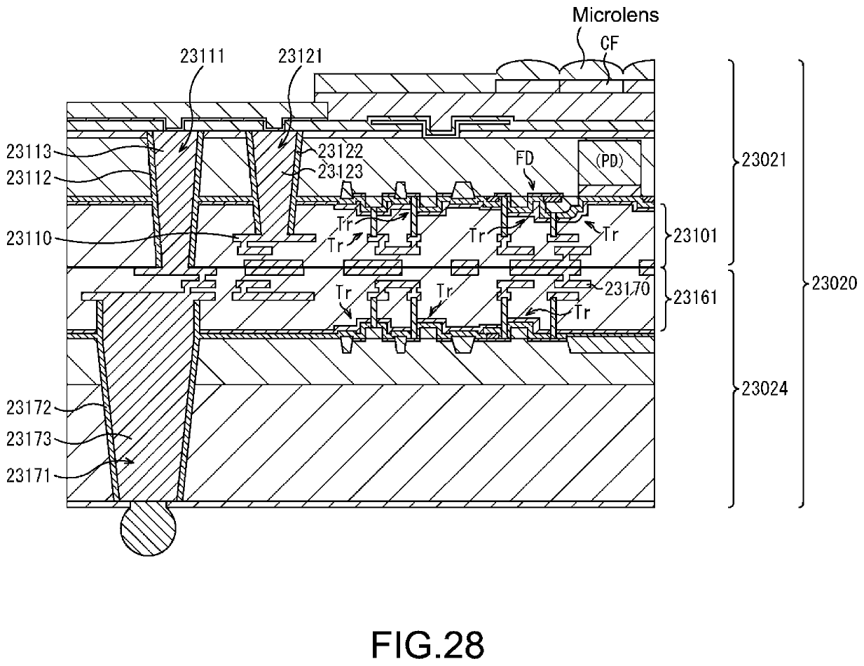

FIG. 28 is a cross-sectional view showing a third configuration example of the stacked-type solid-state imaging apparatus 23020.

In the solid-state imaging apparatus 23020 of FIG. 28, the film 23191 such as the protection film is not formed in a face on which the sensor die 23021 and the logic die 23024 are bonded to each other. In the case of FIG. 26, the film 23191 such as the protection film is formed in the face on which the sensor die 23021 and the logic die 23024 are bonded to each other. In this point, the solid-state imaging apparatus 23020 of FIG. 28 is different from the case of FIG. 26.

The sensor die 23021 and the logic die 23024 are superimposed on each other such that the wires 23110 and 23170 are held in direct contact. Then, the wires 23110 and 23170 are directly joined with each other by heating the wires 23110 and 23170 while adding necessary weight on the wires 23110 and 23170. In this manner, the solid-state imaging apparatus 23020 of FIG. 28 is formed.

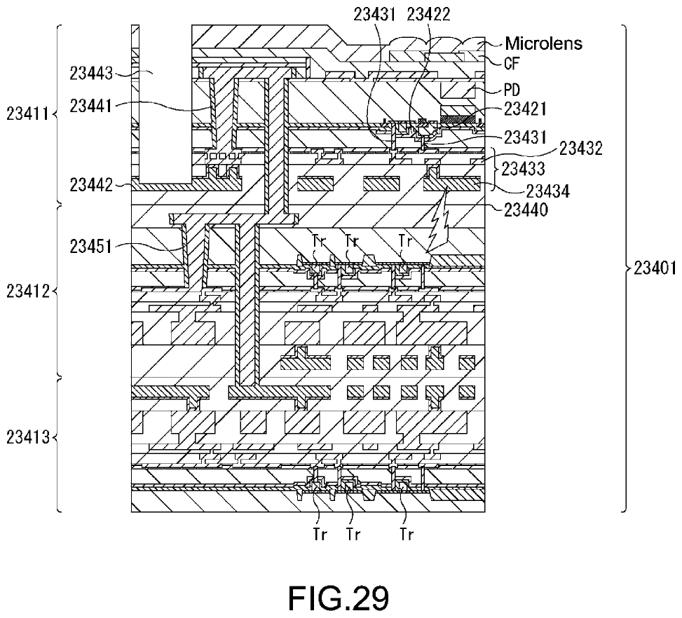

FIG. 29 is a cross-sectional view showing another configuration example of the stacked-type solid-state imaging apparatus to which the technology according to the present disclosure can be applied.

In FIG. 29, a solid-state imaging apparatus 23401 has a three-layer laminate structure. In this three-layer laminate structure, three dies of a sensor die 23411, a logic die 23412, and a memory die 23413 are stacked.

The memory die 23413 includes a memory circuit. The memory circuit stores data temporarily necessary in signal processing performed in the logic die 23412, for example.

In FIG. 29, the logic die 23412 and the memory die 23413 are stacked below the sensor die 23411 in the stated order. However, the logic die 23412 and the memory die 23413 may be stacked below the sensor die 23411 in inverse order, i.e., in the order of the memory die 23413 and the logic die 23412.

Note that, in FIG. 29, a PD that becomes a photoelectric converter of the pixel and source/drain regions of a pixel Tr are formed in the sensor die 23411.

A gate electrode is formed via a gate insulation film around the PD. A pixel Tr 23421 and a pixel Tr 23422 are formed by the gate electrode and the paired source/drain regions.

The pixel Tr 23421 adjacent to the PD is a transfer Tr. One of the paired source/drain regions that constitute the pixel Tr 23421 is an FD.

Further, an inter-layer insulation film is formed in the sensor die 23411. A connection hole is formed in the inter-layer insulation film. The pixel Tr 23421 and connection conductors 23431 that connects to the pixel Tr 23422 are formed in the connection hole.

In addition, a wiring layer 23433 having a plurality of layers with layer wires 23432 which connect to each of the connection conductors 23431 is formed in the sensor die 23411.

Further, an aluminum pad 23434 that becomes an electrode for external connection is formed in a lowermost layer of the wiring layer 23433 of the sensor die 23411. Specifically, in the sensor die 23411, the aluminum pad 23434 is formed at a position closer to a surface 23440 bonding with the logic die 23412 than the wires 23432. The aluminum pad 23434 is used as one end of a wire associated with input/output of signals into/from the outside.

In addition, a contact 23441 used for electric connection with the logic die 23412 is formed in the sensor die 23411. The contact 23441 is connected to a contact 23451 of the logic die 23412 and also connected to an aluminum pad 23442 of the sensor die 23411.

Then, a pad hole 23443 is formed in the sensor die 23411, reaching the aluminum pad 23442 from a backside (upper side) of the sensor die 23411.

The technology according to the present disclosure can be applied to the solid-state imaging apparatus as described above.

It should be noted that the present disclosure can also take the following configurations.
<1> An imaging apparatus, including:
a solid-state imaging element configured to photoelectrically convert received light into an electric signal corresponding to an amount of the received light;
a lower layer lens that is a part of a lens group including a plurality of lenses configured to condense the received light, the lower layer lens being placed at a position in front of the solid-state imaging element, the position being closer to the solid-state imaging element than an upper layer lens that is a different part of the lens group; and
a cavity layer including an air layer, the cavity layer being formed between the lower layer lens and the solid-state imaging element.
<2> The imaging apparatus according to <1>, further including
a CSP (Chip Size Package) solid-state imaging element including
a glass substrate configured to fix the solid-state imaging element, the solid-state imaging element and the glass substrate being integrated, in which
the lower layer lens includes a convex portion in a peripheral portion of a back surface of the lower layer lens, which is opposed to a front surface of the lower layer lens, which is on an incident side of the light, the lower layer lens excluding the convex portion being adhered to an infrared cut filter configured to cut infrared light by a transparent adhesive, the convex portion and a front surface of the glass substrate, which is on the incident side of the light, being adhered to each other by a transparent adhesive, and
the cavity layer is formed between the infrared cut filter and the glass substrate.
<3> The imaging apparatus according to <2>, in which
the convex portion includes a spacer separate from the lower layer lens.
<4> The imaging apparatus according to <3>, in which
the spacer includes an air path that is a passageway for the air in the cavity layer.
<5> The imaging apparatus according to <1>, further including
a CSP (Chip Size Package) solid-state imaging element including
a glass substrate configured to fix the solid-state imaging element, the solid-state imaging element and the glass substrate being integrated, in which
the lower layer lens includes a convex portion in a peripheral portion of a back surface of the lower layer lens, which is opposed to a front surface of the lower layer lens, which is on an incident side of the light, the convex portion and a front surface of the glass substrate, which is on the incident side of the light, being adhered to each other by a transparent adhesive,
between the solid-state imaging element and the glass substrate, an infrared cut filter configured to cut infrared light is adhered by a transparent adhesive, and
the cavity layer is formed between the lower layer lens and the glass substrate.
<6> The imaging apparatus according to <1>, further including
a CSP (Chip Size Package) solid-state imaging element including
a glass substrate configured to fix the solid-state imaging element, the solid-state imaging element and the glass substrate being integrated, in which
the lower layer lens includes a convex portion in a peripheral portion of a back surface of the lower layer lens, which is opposed to a front surface of the lower layer lens, which is on an incident side of the light, the convex portion and a front surface of the glass substrate, which is on the incident side of the light, being adhered to each other by a transparent adhesive,
the glass substrate has a function as an infrared cut filter having small warpage and distortion, and
the cavity layer is formed between the lower layer lens and the infrared cut filter.
<7> The imaging apparatus according to <6>, in which
the glass substrate is formed of soda-lime glass.
<8> The imaging apparatus according to <1>, further including
a CSP (Chip Size Package) solid-state imaging element including
a glass substrate configured to fix the solid-state imaging element, the solid-state imaging element and the glass substrate being integrated, in which
the lower layer lens includes a convex portion in a peripheral portion of a back surface of the lower layer lens, which is opposed to a front surface of the lower layer lens, which is on an incident side of the light, the lower layer lens being adhered to an infrared cut filter configured to cut infrared light by a transparent adhesive,
the infrared cut filter includes a front surface, which is on the incident side of the light, and a back surface opposed to the front surface, the back surface being adhered to a front surface of the glass substrate, which is on the incident side of the light, by a transparent adhesive, and
the cavity layer is formed between the lower layer lens and the infrared cut filter.
<9> The imaging apparatus according to <1>, in which
the lower layer lens includes a plurality of lenses.
<10> The imaging apparatus according to <2>, further including
a light absorbing material having a function of absorbing light, the light absorbing material being provided to cover a side surface of the CSP solid-state imaging element.
<11> The imaging apparatus according to <10>, further including
a spacer for fixing the CSP solid-state imaging element and a circuit substrate, in which
the light absorbing material is a fixing agent having a function of absorbing light, the fixing agent fixing the CSP solid-state imaging element and the spacer.
<12> The imaging apparatus according to <10>, in which
the light absorbing material is a mask having a function of absorbing light, the mask being formed by performing mask processing.
<13> The imaging apparatus according to any of <1> to <12>, further including
a fixing portion configured to guide the solid-state imaging element to a predetermined position on a circuit substrate in a case of mounting the solid-state imaging element.
<14> The imaging apparatus according to <13>, in which
the fixing portion is further configured to guide at least two sides of the solid-state imaging element having a rectangular shape to predetermined positions on the circuit substrate.
<15> The imaging apparatus according to <13>, in which
the fixing portion is further configured to guide four corners of the solid-state imaging element having a rectangular shape to predetermined positions on the circuit substrate.
<16> The imaging apparatus according to any of <1> to <15>, further including
a signal processing unit configured to perform, in the solid-state imaging element, processing on an image signal formed of the electric signal corresponding to the amount of the received light, which is obtained by photoelectrically converting the received light, the processing including correcting a displacement between an incident position of incident light entering the solid-state imaging element and an incident position of a totally-reflected and turned-back component, the totally-reflected and turned-back component re-entering the solid-state imaging element in such a manner that the incident light is totally reflected on an imaging surface of the solid-state imaging element and the resulting totally-reflected component of the incident light is reflected at a boundary with the cavity layer.
<17> The imaging apparatus according to <16>, in which
the displacement between the incident position of the incident light entering the solid-state imaging element and the incident position of the totally-reflected and turned-back component is substantially constant, the totally-reflected and turned-back component re-entering the solid-state imaging element in such a manner that the incident light is totally reflected on the imaging surface of the solid-state imaging element and the resulting totally-reflected component of the incident light is reflected at the boundary with the cavity layer.
<18> An electronic apparatus, including:
a solid-state imaging element configured to photoelectrically convert received light into an electric signal corresponding to an amount of the received light; a lower layer lens that is a part of a lens group including a plurality of lenses configured to condense the received light, the lower layer lens being placed at a position in front of the solid-state imaging element, the position being closer to the solid-state imaging element than an upper layer lens that is a different part of the lens group; and
a cavity layer including an air layer, the cavity layer being formed between the lower layer lens and the solid-state imaging element.
<19> A manufacturing method for an imaging apparatus including
a solid-state imaging element configured to photoelectrically convert received light into an electric signal corresponding to an amount of the received light,
a lower layer lens that is a part of a lens group including a plurality of lenses configured to condense the received light, the lower layer lens being placed at a position in front of the solid-state imaging element, the position being closer to the solid-state imaging element than an upper layer lens that is a different part of the lens group, and
a cavity layer including an air layer, the cavity layer being formed between the lower layer lens and the solid-state imaging element, the manufacturing method including: fixing the solid-state imaging element to a circuit substrate; and
mounting the lower layer lens on the solid-state imaging element such that the cavity layer is formed.
<20> An imaging apparatus, comprising:
an imaging structure including:
an imaging element that converts received light into electric charge;
a transparent substrate disposed on the imaging element;
at least one lens disposed on the transparent substrate; and
an air cavity between the transparent substrate and the at least one lens.
<21> The imaging apparatus according to <20>, wherein
the at least one lens includes a first surface and a second surface opposite to the first surface, and
the first surface includes a concave portion.
<22> The imaging apparatus according to one or more of <20> to <21>, wherein
the second surface includes at least one protrusion fixed to the transparent substrate such that the air cavity is defined between the transparent substrate and the at least one lens.
<23> The imaging apparatus according to one or more of <20> to <22>, wherein
the at least one protrusion is fixed to the transparent substrate by an adhesive.
<24> The imaging apparatus according to one or more of <20> to <23>, further comprising:
a circuit substrate including a circuit;
a spacer including at least one fixing portion that guides the imaging structure to a desired position on the circuit substrate when the imaging structure is mounted on the circuit substrate; and
a light absorbing material disposed on at least one side surface of the imaging structure such that that light absorbing material is between the imaging structure and the at least one fixing portion.
<25> The imaging apparatus according to one or more of <20> to <24>, wherein
the at least one side surface of the imaging structure includes a side surface of the at least one lens.
<26> The imaging apparatus according to one or more of <20> to <25>, wherein
the light absorbing material is disposed on the first surface of the at least one lens.
<27> The imaging apparatus according to one or more of <20> to <26>, wherein
the at least one fixing portion includes four fixing portions that guide the imaging structure to the desired position.
<28> The imaging apparatus according to one or more of <20> to <27>, wherein
the four fixing portions are defined by a cavity in the spacer and have shapes that guide respective corners of the imaging structure to the desired position, and
the at least one side surface of the imaging structure includes side surfaces at locations that correspond to the respective corners.
<29> The imaging apparatus according to one or more of <20> to <28>, wherein
the light absorbing material is disposed on an entirety of the side surfaces at the locations that correspond to the respective corners.
<30> The imaging apparatus according to one or more of <20> to <29>, wherein the imaging structure further comprises:
an infrared cut filter between the transparent substrate and the at least one lens.
<31> The imaging apparatus according to one or more of <20> to <30>, wherein
the infrared cut filter is adhered to the second surface of the at least one lens such that the air cavity is between the infrared cut filter and the transparent substrate.
<32> The imaging apparatus according to one or more of <20> to <31>, wherein the at least one lens includes a plurality of lenses.
<33> The imaging apparatus according to one or more of <20> to <32>, wherein the imaging structure further comprises:
a lens stack including a plurality of lenses, wherein the lens stack is spaced apart from the at least one lens; and
an actuator that supports the lens stack.
<34> The imaging apparatus according to one or more of <20> to <33>, wherein
the transparent substrate is an infrared cut filter.
<35> The imaging apparatus according to one or more of <20> to <34>, wherein
the at least one lens includes a first surface and a second surface opposite to the first surface,
the first surface includes a concave portion, and
the second surface includes at least one protrusion fixed to the infrared cut filter such that the air cavity is defined between the infrared cut filter and the at least one lens.
<36> The imaging apparatus according to one or more of <20> to<35>, wherein
the at least one protrusion is at a peripheral of the at least one lens.
<37> The imaging apparatus according to one or more of <20> to<36>, wherein
the at least one protrusion is fixed to the infrared cut filter at a peripheral of the infrared cut filter.
<38> An electronic apparatus, comprising:
a signal processing unit; and
an imaging apparatus including:
an imaging structure including:
an imaging element that converts received light into electric charge;
a transparent substrate disposed on the imaging element;
at least one lens disposed on the transparent substrate; and
an air cavity between the transparent substrate and the at least one lens.
<39> The electronic apparatus according to <38>, wherein
the at least one lens includes a first surface and a second surface opposite to the first surface
the first surface includes a concave portion, and
the second surface includes at least one protrusion fixed to the transparent substrate such that the air cavity is defined between the transparent substrate and the at least one lens.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Solid-state imaging element

2 Glass substrate

4 Infrared cut filter

5 Cavity

6 Lens

7 Circuit board

8 Actuator

9 Connector

10 Spacer

11, 11-1 to 11-4, 11-21 to 11-24, 11-31, 11-32, 11-41 to 11-43, 11-51, 11-52 Fixing portion

12 Semiconductor component

13, 13-1 to 13-4, 13-21 to 13-24, 13-31, 13-32, 13-41 to 1#-43, 13-51, 13-52 Fixing agent

31, 32 Adhesive

41 Glass substrate

61 Upper layer lens

62 Lower layer lens

81 Mask

91 ACF terminal

111 Lens

131 Spacer

What is claimed is:

1. An imaging apparatus, comprising:
an imaging structure including:
an imaging element that converts received light into electric charge;
a transparent substrate disposed on the imaging element;
at least one lens disposed on the transparent substrate; and
an air cavity between the transparent substrate and the at least one lens.

2. The imaging apparatus according to claim 1, wherein
the at least one lens includes a first surface and a second surface opposite to the first surface, and
the first surface includes a concave portion.

3. The imaging apparatus according to claim 2, wherein
the second surface includes at least one protrusion fixed to the transparent substrate such that the air cavity is defined between the transparent substrate and the at least one lens.

4. The imaging apparatus according to claim 3, wherein
the at least one protrusion is fixed to the transparent substrate by an adhesive.

5. The imaging apparatus according to claim 2, further comprising:
a circuit substrate including a circuit;
a spacer including at least one fixing portion that guides the imaging structure to a desired position on the circuit substrate when the imaging structure is mounted on the circuit substrate; and
a light absorbing material disposed on at least one side surface of the imaging structure such that that light absorbing material is between the imaging structure and the at least one fixing portion.

6. The imaging apparatus according to claim 5, wherein
the at least one side surface of the imaging structure includes a side surface of the at least one lens.

7. The imaging apparatus according to claim 6, wherein
the light absorbing material is disposed on the first surface of the at least one lens.

8. The imaging apparatus according to claim 5, wherein
the at least one fixing portion includes four fixing portions that guide the imaging structure to the desired position.

9. The imaging apparatus according to claim 8, wherein
the four fixing portions are defined by a cavity in the spacer and have shapes that guide respective corners of the imaging structure to the desired position, and
the at least one side surface of the imaging structure includes side surfaces at locations that correspond to the respective corners.

10. The imaging apparatus according to claim 9, wherein
the light absorbing material is disposed on an entirety of the side surfaces at the locations that correspond to the respective corners.

11. The imaging apparatus according to claim 1, wherein the imaging structure further comprises:
an infrared cut filter between the transparent substrate and the at least one lens.

12. The imaging apparatus according to claim 10, wherein
the infrared cut filter is adhered to the second surface of the at least one lens such that the air cavity is between the infrared cut filter and the transparent substrate.

13. The imaging apparatus according to claim 1, wherein the at least one lens includes a plurality of lenses.

14. The imaging apparatus according to claim 1, wherein the imaging structure further comprises:
a lens stack including a plurality of lenses, wherein the lens stack is spaced apart from the at least one lens; and
an actuator that supports the lens stack.

15. The imaging apparatus according to claim 1, wherein
the transparent substrate is an infrared cut filter.

16. The imaging apparatus according to claim 15, wherein
the at least one lens includes a first surface and a second surface opposite to the first surface,
the first surface includes a concave portion, and
the second surface includes at least one protrusion fixed to the infrared cut filter such that the air cavity is defined between the infrared cut filter and the at least one lens.

17. The imaging apparatus according to claim 16, wherein
the at least one protrusion is at a peripheral of the at least one lens.

18. The imaging apparatus according to claim 17, wherein
the at least one protrusion is fixed to the infrared cut filter at a peripheral of the infrared cut filter.

19. An electronic apparatus, comprising:
a signal processing unit; and
an imaging apparatus including:
an imaging structure including:
an imaging element that converts received light into electric charge;
a transparent substrate disposed on the imaging element;
at least one lens disposed on the transparent substrate; and
an air cavity between the transparent substrate and the at least one lens.

20. The electronic apparatus according to claim 19, wherein
the at least one lens includes a first surface and a second surface opposite to the first surface,
the first surface includes a concave portion, and
the second surface includes at least one protrusion fixed to the transparent substrate such that the air cavity is defined between the transparent substrate and the at least one lens.
